(19) United States
(12) Patent Application Publication
(10) Pub. No.: US 2012/0215670 A1
(43) Pub. Date: Aug. 23, 2012

(54) Method, System and Computer Program Product for Processing Tax Notices

(76) Inventor: Rick W. Pinkerman, San Clemente, CA (US)

(21) Appl. No.: 13/033,575

(22) Filed: Feb. 23, 2011

(51) Int. Cl. G06Q 40/00

(52) U.S. Cl. 705/31

(57) ABSTRACT

A method, system and computer program product includes entering information from a tax notification into a system using a workflow where the system searches a database for a matching company. The system determines a status of the tax notification, generates a template letter to be communicated to the company, and places the tax notification on an active notice listing. An active notification is selected to process using a workflow. A research workflow is selected if research of the active notification is required. The system stores the research results in the database, determines a change in status of the active notification, and generates a template letter to the company. An actuals workflow is selected if payment of penalties and interest or receipt of refund is required. The system presents an abatement workflow when penalties and interest are due and generates template letters to the company of and an agency.

### CROSS-REFERENCE TO RELATED APPLICATIONS

The present Utility patent application claims priority benefit of the U.S. provisional application for patent Ser. No. 61/257,737 filed on Nov. 3, 2009 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to systems and methods for accounting service firms. More particularly, the invention is related to solutions for effectively entering, storing, tracking, analyzing, managing, sharing, resolving, reporting and communicating payroll tax related notices.

### BACKGROUND OF THE INVENTION

Accounting service firms such as Payroll Service Bureaus (PSBs) and CPA firms typically receive agency payroll tax notices on behalf of their clients for efforts related to managing their client's payroll tax responsibilities. Furthermore, multi-state employers receive notices from a variety of agencies related to payroll taxes and employment related issues. In the course of managing their client's tax responsibilities, PSBs often collect funds from their clients for their tax liabilities and pay their client's taxes in the appropriate amounts on or prior to the appropriate dates. Tax notices are normally received by PSBs from various State and Federal Agencies as well as foreign and international agencies. The types of notices can vary significantly and typically deal with matters related, but not limited, to changes, errors, clarifications and or other situations regarding filed forms, tax liabilities or account information on file with the various agencies. The volume of tax notices transmitted by the various agencies increases every year as tax laws change and as a result requires significantly more effort on the part of PSBs to manage and resolve. The clients of the PSB may perceive tax notices as a lack of service and or that the PSB has not performed their duties correctly. When a client receives a tax notice stating “intent to levy, amount due” and the PSB does not provide the client adequate information related to the cause of the issue, how the issue will resolved and/or when the issue will be resolved, clients may lose trust in the ability of a PSB to adequately service their needs. The lack of a systematic method for updating clients with standard and streamlined communications related to their tax notices may result in a PSB losing clients. Furthermore, PSB staff may suffer from increased stress as a result of issues related to the processing tax notices of PSB clients.

Notices transmitted by the agencies vary significantly from agency-to-agency with respect to form, function, procedures and due dates. For example, agencies require a certain form from a PSB in order for the PSB to represent a client and the PSB is required to record and maintain those documents and also to transmit the documents by facsimile to the agency as needed. Dealing with the various steps required by the various agencies is a tedious and time consuming process for PSBs.

PSBs develop and maintain communication with various agencies by way of contacts at the agencies. Agency contacts provide clarification of issues, requests for data and requests for due date extensions among other things. Conventionally, a relationship with an agency and/or agency contact is initiated and developed by a particular PSB staff member and as a result it is difficult for other staff members to take advantage of the relationship developed with the agency and its related agency contacts.

Due dates for agency tax notices are required to be met in order to ensure additional costs are not accrued by the PSB, as penalties and interest are incurred and continue to increase if notices are not resolved by the appropriate date. When notices are not resolved in an appropriate time frame, PSBs are required to perform research in order to determine the cause for the unresolved notice. The findings of the research are required to be relayed to clients, internal staff, third parties and agencies. Conventional methods for communicating PSB research findings to the various parties involved are not standardized. PSB research findings are typically communicated to clients by letter. Letters related to research findings are created by PSB staff members from scratch and as a result is a time consuming process which limits PSBs capabilities with respect to resolving notices in an efficient and time effective manner.

Research performed by PSBs includes generating and reviewing reports created by PSB payroll software, collaborating with internal staff members regarding the circumstances surrounding the issue and generating detailed notes. The process of performing research by PSBs is time consuming and in some cases can require up to sixteen hours of staff effort to complete. Conventionally, PSB research related notes are written on note pads or on the back of the received notice for later review. A systematic process is needed by PSBs for performing notice related research to decrease the amount of research required and increase the efficiency of performing the research.

If the results of the research performed by the PSB indicate an amount is due and the PSB is at fault, then the PSB generally requests an abatement of penalties and interest. An abatement request is generally handled by PSB staff members through the creation of a time consuming custom letter for transmission to the respective agency. Conventional abatement requests are usually generated with five different types of correspondence, generally denoted as administrative waiver, correction of service error, good compliance, reasonable cause and statutory exception. Due to the complexity of requesting an abatement, the easiest and least time consuming abatement correspondence, three year good compliance, is typically chosen by PSB staff members, even though it may not be the most appropriate or the most effective. Hence, a streamlined and automated process for generating abatement requests by notice type is needed by PSBs in order to maximize efficiency and effectiveness.

Conventionally, the overall status statistics maintained by PSBs for notices is inaccurate. For example, a notice may be denoted by PSB status statistics as closed since a request has been transmitted to the appropriate agency, however, the agency may consider the notice as not having been resolved and may request further information before resolving the notice. In cases where agencies request additional information, the notice is reopened by the PSB for further effort in order to resolve the notice. For example, the overall status statistics maintained by PSBs for notices may indicate thirty notices have been closed, when in actuality only five notices have been totally resolved and closed. Furthermore, a notice considered closed by the PSB, but actually open, may continue to accrue additional penalties and interest. Notices should not be denoted by PSBs as closed until correspondence is received by the respective agency indicating the notice has been resolved. Additionally, resolution of notices can take up to sixteen months to resolve, further complicating this process. Maintaining an accurate record for a notice for an extended amount of time can be difficult, especially if agency contacts, client contacts or PSB staff changes occur. Furthermore, PSB notes and research are required by each agency to prove the PSB followed their instructions to be maintained and this requirement is difficult to execute conventionally. Automated and accurate processes for maintaining overall status statistics for notices is needed by PSBs in order to have an accurate knowledge of open and closed notices with each steps individual notes so the notices can be resolved in an effective and efficient manner.

Many of the elements of the conventional process for resolving notices by PSBs are performed using computerized spreadsheet and word-processing software. Efficient collaboration and communication between PSB staff, agencies and customers is difficult using this software as the software was developed and intended to be used by individuals in a non-collaborative environment. A streamlined methodology is needed enabling PSB staff, agencies and customers to collaborate and communicate in an efficient manner for resolving notices.

Conventional methodologies for resolving agency tax notices using paper oriented processes and/or using software developed for use by individuals results in an inefficient, unwieldy and uncoordinated process. For example, conventional methods for collecting, organizing and transmitting the cumulative information related to a client's notices can require up to sixteen hours of staff member effort to complete. This process is subject to errors resulting in unnecessary costs due to penalties, interest and excessive efforts performed by PSB staff members. Therefore, a methodology is needed where agency tax notices can be efficiently and effectively stored, tracked, analyzed, managed and resolved, and where related efforts can be efficiently and effectively reported and communicated.

Conventional processes for resolving notices are difficult to diagnose for sources of errors and inefficiencies as information is often stored in random locations and not universally available. Accordingly, a system is needed for resolving notices which enables easy analysis and diagnosis of the process in order to prevent errors from recurring and for reducing inefficiencies.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-H presents a flow chart illustrating entry of a new notice for an agency notice tracking system, in accordance with an embodiment of the present invention;

FIGS. 2A-G presents a flow chart illustrating processing of a notice for an agency notice tracking system, in accordance with an embodiment of the present invention;

FIGS. 3A-E presents a flow chart illustrating entry of a Bulk Tax Notice Entry for an agency notice tracking system, in accordance with an embodiment of the present invention;

FIG. 4 presents a flow chart illustrating a Rapid Tax Notice Entry for an agency notice tracking system, in accordance with an embodiment of the present invention;

FIG. 5 presents a flow chart illustrating creation of a template letter for an agency notice tracking system, in accordance with an embodiment of the present invention;

FIG. 6 presents a flow chart illustrating uploading a document for an agency notice tracking system, in accordance with an embodiment of the present invention; and

FIG. 7 illustrates a typical computer system that, when appropriately configured or designed, can serve as a computer system 700 in which the present invention may be embodied.

### SUMMARY OF THE INVENTION

To achieve the forgoing and other objects and in accordance with the purpose of the invention, a method, system and computer program product for processing tax notices is presented.

In one embodiment a method includes steps for entering information from at least one agency tax notification into a system using a workflow presented by the system where the system is operable to search a database, to determine a status of the at least one agency tax notification, to generate a template letter, and to place the at least one agency tax notification on an active notice listing dependent upon the determined status. The method includes steps for selecting an active notification from the active notice listing to process using a workflow and retrieved information presented by the system. The method includes steps for selecting a research workflow and entering results of the research into the system where the system is operable to store the research results in the database, to determine a change in status, and to generate a template letter. The method also includes steps for selecting an actuals workflow for payment of penalties and interest or receipt of refund where the system is operable for presenting an abatement workflow when penalties and interest are due, generates template letters and presents a closure workflow when the processing is complete. Another embodiment further includes steps for configuring a workflow for a type of an agency tax notification. Yet another embodiment further includes steps for creating a template letter.

In another embodiment a method includes the steps of entering information from at least one agency tax notification into a system using a workflow presented by the system where the system is operable to search a database for a company matching an identifier from the entered information and to present results from the search for verification. The system is further operable to determine a status of the at least one agency tax notification, to generate a template letter regarding the at least one agency tax notification and the determined status to be communicated to the company, and to place the at least one agency tax notification on an active notice listing dependent upon the determined status. The method includes selecting an active notification from the active notice listing to process using a workflow presented by the system where the system is operable to retrieve information associated with the selected active notification. The method includes selecting a research workflow if research of the selected active notification is required to resolve the selected active notification and entering results of the research into the system. The system is operable to store the research results in the database, to determine a change in status of the selected active notification dependent upon the research results, and to generate a template letter regarding the selected active notification and the determined status to be communicated to the company of the selected active notification. The method also includes selecting an actuals workflow if payment of penalties and interest or receipt of refund is required to complete the processing of the selected active notification. The system is operable to present an abatement workflow when penalties and interest are due and to generate template letters to be communicated to the company of the selected active notification and an agency responsible for the selected active notification. The system being further operable for presenting a closure workflow when the processing is complete. In another embodiment the at least one agency tax notification is received via a transmission from the company for automated entry into the system. In yet another embodiment the at least one agency tax notification is associated with a plurality of companies and the system generates a multiple company notice and generates a template letter for each company. In still another embodiment the system is further operable for determining if the at least one agency tax notification is a duplicate of a previously entered agency tax notification. In another embodiment the system is further operable for determining if the at least one agency tax notification is a sequential notice of a previously entered agency tax notification and for adding the sequential notice to the previously entered agency tax notification. In yet another embodiment the system is further operable for identifying a type of the at least one agency tax notification to enable the system to present workflows associated with the type. Still another embodiment further includes the step of configuring a workflow for each notice type. Another embodiment further includes the step of creating a template letter. In yet another embodiment the system is further operable to save in the database a document supplied by the company. In still another embodiment the retrieved information associated with the selected active notification comprises agency contact information and identification required to represent the company of the selected active notification.

In another embodiment a system includes means for storing company and agency information, means for non-transitorily storing a plurality of instructions, means for executing the instructions, and means for entering information from at least one agency tax notification into the storing means. Execution of the instructions cause the executing means to search the storing means for a company matching an identifier from the entered information, to present results from the search for verification, to determine a status of the at least one agency tax notification, to generate a template letter regarding the at least one agency tax notification and the determined status to be communicated to the company, and to place the at least one agency tax notification on an active notice listing dependent upon the determined status. The entering means being further operable for selecting an active notification from the active notice listing to process using a workflow. Execution of the instructions cause the executing means to retrieve information associated with the selected active notification. The entering means being further operable for selecting a research workflow if research of the selected active notification is required to resolve the selected active notification and for entering results of the research. Execution of the instructions cause the executing means to store the research results in the storing means, to determine a change in status of the selected active notification dependent upon the research results, and to generate a template letter regarding the selected active notification and the determined status to be communicated to the company of the selected active notification. The interface being further operable for selecting an actuals workflow if payment of penalties and interest or receipt of refund is required to complete the processing of the selected active notification. Execution of the instructions cause the executing means to present an abatement workflow when penalties and interest are due, to generate template letters to be communicated to the company of the selected active notification and an agency responsible for the selected active notification, and to present a closure workflow when the processing is complete. Another embodiment further includes means for the at least one agency tax notification to be received via a transmission from the company for automated entry into the system.

In another embodiment a system includes a database for storing company and agency information. A storage means non-transitorily stores a plurality of instructions. One or more processors are operable for executing the instructions. An interface, under control of the one or more processors executing the instructions, is operable for entering information from at least one agency tax notification into the database using a workflow presented by the interface. Execution of the instructions cause the one or more processors to search the database for a company matching an identifier from the entered information, to present results from the search for verification, to determine a status of the at least one agency tax notification, to generate a template letter regarding the at least one agency tax notification and the determined status to be communicated to the company, and to place the at least one agency tax notification on an active notice listing dependent upon the determined status. The interface being further operable for selecting an active notification from the active notice listing to process using a workflow. Execution of the instructions cause the one or more processors to retrieve information associated with the selected active notification. The interface being further operable for selecting a research workflow if research of the selected active notification is required to resolve the selected active notification and for entering results of the research. Execution of the instructions cause the one or more processors to store the research results in the database, to determine a change in status of the selected active notification dependent upon the research results, and to generate a template letter regarding the selected active notification and the determined status to be communicated to the company of the selected active notification. The interface being further operable for selecting an actuals workflow if payment of penalties and interest or receipt of refund is required to complete the processing of the selected active notification. Execution of the instructions cause the one or more processors to present an abatement workflow when penalties and interest are due, to generate template letters to be communicated to the company of the selected active notification and an agency responsible for the selected active notification, and to present a closure workflow when the processing is complete. Another embodiment further includes a network by which the at least one agency tax notification is received via a transmission from the company for automated entry into the system. In yet another embodiment the at least one agency tax notification is associated with a plurality of companies and execution of the instructions cause the one or more processors to generate a multiple company notice and generate a template letter for each company. In still another embodiment execution of the instructions cause the one or more processors to determine if the at least one agency tax notification is a duplicate of a previously entered agency tax notification. In another embodiment execution of the instructions cause the one or more processors to determine if the at least one agency tax notification is a sequential notice of a previously entered agency tax notification and to add the sequential notice to the previously entered agency tax notification. In yet another embodiment execution of the instructions cause the one or more processors to identify a type of the at least one agency tax notification to enable presentation of workflows associated with the type. In still another embodiment the interface being further operable for configuring a workflow for the type. In another embodiment the interface being further operable for creating a template letter. In yet another embodiment execution of the instructions cause the one or more processors to save in the database a document supplied by the company. In still another embodiment the retrieved information associated with the selected active notification comprises agency contact information and identification required to represent the company of the selected active notification.

In another embodiment a computer program product residing on or being distributed across one or more non-transitory computer readable mediums having a plurality of instructions stored thereon which, when executed by one or more associated processors, cause the one or more processors to enter information from at least one agency tax notification into a system using a workflow presented by the system. The system is operable to search a database for a company matching an identifier from the entered information and to present results from the search for verification. The system is further operable to determine a status of the at least one agency tax notification, to generate a template letter regarding the at least one agency tax notification and the determined status to be communicated to the company, and to place the at least one agency tax notification on an active notice listing dependent upon the determined status. One or more processors select an active notification from the active notice listing to process using a workflow presented by the system where the system is operable to retrieve information associated with the selected active notification. One or more processors select a research workflow if research of the selected active notification is required to resolve the selected active notification and entering results of the research into the system. The system is operable to store the research results in the database, to determine a change in status of the selected active notification dependent upon the research results, and to generate a template letter regarding the selected active notification and the determined status to be communicated to the company of the selected active notification. One or more processors select an actuals workflow if payment of penalties and interest or receipt of refund is required to complete the processing of the selected active notification. The system is operable to present an abatement workflow when penalties and interest are due and to generate template letters to be communicated to the company of the selected active notification and an agency responsible for the selected active notification. The system is further operable for presenting a closure workflow when the processing is complete. In another embodiment the at least one agency tax notification is received via a transmission from the company for automated entry into the system. In yet another embodiment the at least one agency tax notification is associated with a plurality of companies and the system generates a multiple company notice and generates a template letter for each company. In still another embodiment the system is further operable for determining if the at least one agency tax notification is a duplicate of a previously entered agency tax notification. In another embodiment the system is further operable for determining if the at least one agency tax notification is a sequential notice of a previously entered agency tax notification and for adding the sequential notice to the previously entered agency tax notification. In yet another embodiment the system is further operable for identifying a type of the at least one agency tax notification to enable the system to present workflows associated with the type. Still another embodiment further includes instructions when executed by one or more associated processors cause the one or more processors to configuring a workflow for the type. Another embodiment further includes instructions when executed by one or more associated processors cause the one or more processors to creating a template letter. In yet another embodiment the system is further operable to save in the database a document supplied by the company. In still another embodiment the retrieved information associated with the selected active notification comprises agency contact information and identification required to represent the company of the selected active notification.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the present invention are discussed below with reference to the Figures. However, those skilled in the art will readily appreciate that the detailed description given herein with respect to these figures is for explanatory purposes as the present invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the present invention that are too numerous to be listed but that all fit within the scope of the present invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

A first embodiment of the present invention will next be described, which provide means and methods at least for the following activities including, but not limited to, entering, tracking, managing, reporting, communicating, resolving and analyzing various types of agency notices that multi-state employers receive, as well as businesses providing accounting services, including but not limited to Payroll Service Bureaus (PSBs) and CPA firms, receive on behalf of their clients. Other uses for the present embodiment include, but are not limited to, employers with employees in multiple states and companies performing their own notice resolution efforts. The present embodiment, as implemented on a typical computer system, includes, but is not limited to, an individual agency Graphical User Interface (GUI) that provides the following information and functionality: quick tax notice entry, rapid tax notice entry, bulk notice entry, active notice listing, client notes, notice notes, agency notes, agency contacts, agency addresses, agency websites with user identification information, passwords, instructions, notice details, and contact related notes enabling PSB staff to maintain notes related to notices and to the contacts which PSB staff collaborate with at the various agencies for resolution of notices.

The present embodiment supports a networked system available to staff members in a localized area and can also be configured to support access from remote locations and from, but not limited to, the Internet by staff, clients, agencies and other entities as needed. The present embodiment provides the capability for receiving notices and other related information from agencies and for transmitting template information to the agencies using secure protocols in many different formats including, but not limited to, XLM, text, comma separated variable (CSV), and AFPDS format.

The present embodiment provides its users the capability to uniquely manage departments, department addresses, department contacts, payment websites, research websites, user identification and passwords in addition to information and instructions for use. The information a PSB collects may be managed within the agency notice tracking system. Information for agencies and local taxing jurisdictions may be maintained, enabling users to tailor the system as needed for the various agencies, as the agencies have varying requirements for receiving communications which they require for resolving notices. Furthermore, the information for agencies and local taxing jurisdictions maintained may also streamline the interaction with their websites, as the respective entities often require third parties to maintain Personal Identification Numbers (PINs) and or other means of identification in order to allow third parties to access their websites.

The present embodiment supports multiple user types enabling PSBs to assign roles within their organizations. Support of multiple user types aids in improving the performance in resolving notices received from the various agencies as the various staff members have areas of responsibilities for which the respective users are trained for and are highly proficient. User access may be controlled or governed based on a user's knowledge level so the user may only receive and process notice types that the user is qualified for access to. Furthermore, control of user access ensures that complex notices are processed by support staff having the appropriate knowledge and experience to resolve the notices. Furthermore control of user access may operate to provide savings with respect to time expended. Furthermore, segmentation of user types prevents access by persons to functions for which they do not have privileges. Furthermore, the present embodiment supports multiple users for efforts including, but not limited to, creating, reviewing, editing and updating notes related to notices. Notes may be assessable from tabs and the various types of notes include, but are not limited to, cause of notice, corrective action, research, closure, avoidable action and follow up. Users of the present embodiment are provided the capability for adding to the drop down menu selections within the application for meeting the ever changing needs of PSBs. Furthermore, the present embodiment provides system configuration GUIs enabling PSBs to manage various system configurations including, but not limited to, user roles, drop down menus, template letters, reports, notice types and PSB configuration.

The present embodiment supports integration with the PSB's payroll processing systems or other external payroll processing systems for ensuring the PSB's client data is current and accurate. The present embodiment supports importation of data from files including, but not limited to company master file, client agency master file and user file. The data imported from these files provide information for aiding resolution teams for resolving notices and communicating their findings with, but not limited to, clients, agencies and staff. Modifications to the data contained in the present embodiment system is performed under revision control ensuring the PSBs maintain accurate data and relieving PSBs of having to support duplicate record retention. A new agency notice workflow is provided by the present embodiment for ensuring the system is updated with accurate and timely information as new notices are received by PSBs. Workflows provide a consistent and reliable method of inputting and processing information. Workflows may provide the user with formatted entry fields for data and instructions on handling the data. Workflows may also provide instructions for offline tasks, such as but not limited to, research, client contact, etc. Workflows may provide the user with a set of tasks that must be finished before the workflow can be closed and a status of a notice can be changed. Furthermore, users may be provided the capability to create custom workflows for a particular issue. The capability provided to update the present embodiment in an accurate and efficient manner reduces errors and ensures clients are communicated with in a standard and appropriate methodology. The staffs of PSBs are provided access to the present embodiment enabling them to add notes to the system and request additional actions as needed. The present embodiment provides PSB staffs the capability to observe the status of notices in the process of being resolved and provide clients detailed information related to efforts performed for a notice. The present embodiment provides an active notice/action list for displaying active notices and other action items. The active notice list is used for opening and editing notices that have been entered into the system and for identifying the status and stage of notices. Notices are denoted with various statuses or stages including, but not limited to, entered, opened, waiting, re-opened, completed and closed. A waiting status is further segmented into, but not limited to, waiting for abatement, agency, client and/or PSB. The various status designations supported by the present embodiment provides users the capability to generate template letters for communication with, but not limited to, agencies and/or clients at each stage of the notice resolution. The interface for generating template letters is multi-threaded, enabling users to open and generate multiple template letters simultaneously as well as access other GUIs simultaneously, as needed. The capability for multi-threaded template creation automates transferring client and notice information into a letter for transmission. The conventional technique for accomplishing this is opening a generic letter and adding the client and notice data into it manually and then saving the file as a different name as not to override the generic letter used each time. Notices are typically displayed and resolved on a first-in-first-out basis, but in some cases a more recently receive notice may be given priority, for example if the notice has an upcoming due date for resolution or there are outstanding tax liabilities. The present embodiment provides various sorting and filtering capabilities for managing the display notices resident in the active notice list. A multiplicity of sorting, organizing and filter schemes are contemplated. By way of example, and not limitation, suitable sorting, organizing and filter include by agency, local agency, tax representative, tax form, notice type, status, difficulty level, category, due date, past due and priority In one approach, notices displayed in the active notice list may be color coded to provide indications for the status of the various notices. Examples of a suitable color coding scheme includes, but is not limited to, a coloration of red indicating an overdue notice, a coloration of blue indicating a customer request for an update. Furthermore, on moving a computer mouse over the areas the details of the notice may be displayed for the users as needed. Those skilled in the art, in light of the teachings of the present invention, will readily recognize a multiplicity of alternative and suitable means for sorting, filtering, and organizing the available notice information for display. The present embodiment provides a GUI for displaying recent activity related to notices. A GUI is displayed by the present embodiment for managing recent notice activity and ensuring efforts related to notices are adequately resolved. Notices can be filtered based on ones needing to be resolved in the near future, for example, but not limited to, today, tomorrow, in the next seven days, two weeks out, 30 days out. The present embodiment provides members of a PSB's staff assigned to resolution of notices the capability, but not limited to, of displaying their respective open notices or displaying the notices of other staff members. Notice details can be viewed on the screen by clicking on the individual notice, which allows staff members to quickly see details in the summary listing. Furthermore, users may operate to modify their page preferences in order to auto-sort a presentation of information to their needs by default. For example, a staff member may need to view the open notices of an absent staff member for ensuring the absent staff member's respective notices are adequately and timely processed.

The present embodiment provides capabilities for automatically categorizing a notice when agencies transmit duplicate, sequential and/or follow up notices. The present embodiment provides the capability for supporting management of the annual, quarterly and amended returns for clients. Furthermore, when a client adjusts a quarter that has already been filed with a single or multiple agencies it causes a new notice to be transmitted to the clients. Furthermore, this notice management allows the PSB to forecast their notice volumes based of client requests for adjustments and allows the user the ability to review a list of clients that had an adjustment at the end of the year in order to verify the correct filing of annual amounts.

The present embodiment provides communication template letters to aid in communicating with, but not limited to, clients, agencies and/or PSB staff members. The communication template generation capability of the present embodiment is integrated with various office applications including, but not limited to email and word processing. Alerts are programmable and may automatically be transmitted to PSB staff members by the present embodiment using email protocols such as, but not limited to, SMTP (Simple Mail Transfer Protocol). The following events that can be customized by the client to ensure efficient operation of notice resolutions are running smooth includes, but is not limited to, entry of a new notice, change of notice status, past due date, request for follow up, waiting response (client/agency), abatement request, refund reply, and new correspondence for a notice. The users have the capability to manage and configure the time timeframe and the person alerted via an alert configuration screen. Possible alerts include, but is not limited to, new note added, letter created, past due date, past follow up date, client follow up request. The capability to create new template letters is provided by the present embodiment enabling users to transmit communication information to appropriate entities including, but not limited by, clients or agencies. The present embodiment provides users the capability to configure and view a template letter as needed with the resulting template letter being saved in a record related to the client's notice and transmitted to, but not limited by, the client or agency by, but not limited to, email, letter or secure protocols. Template letters created and transmitted are maintained for future use with related information including, but not limited to, type of communication, date sent and sender of record. The present embodiment provides users the capability to create new templates and configure them as drop down menu selections ensuring users have the capability to readily access customized template letters for transmission to entities including, but not limited to, clients and/or agencies.

The present embodiment provides users the capability to digitally scan agency notices and other documents and store them in an organized structure related to the respective notices. Users may be provided the capability to configure the dropdown list for categorizing the attachment types with descriptions. In many practical applications, this dropdown list configuration capability may reduce the effort required for legacy paperwork and filing efforts and ameliorate instances of notices becoming lost or misplaced. The present embodiment subjects new notices to several verification processes for ensuring a notice is correctly and accurately entered including, but not limited to, verification of client start and end dates, client tax service start and end dates, agency validity, notice type and notice issue date.

The present embodiment's capability to maintain and track changes related to notices, enables, in many practical applications, audits of clients to be completed more efficiently, because the information related to notices is readily available and easily verified. Notice processes and notice types have estimated completion and closed dates in order to aid users in forecasting workloads and in monitoring and maintaining per user/group workloads and standardized billings.

The present embodiment provides storage and display of information related to notices including, but not limited to, issue tracking, reason for receipt, notice type, and action or actions taken for resolving a notice, it also handles amended returns, and follow up requests. The present embodiment provides multiple workflows for resolving notices including, but not limited to, a workflow for completion of notice related requests where a PSB has completed efforts for a notice request, for requesting information from the agencies based of notice types, for requesting abatements of penalties and interest paid by the PSB, for tracking refund amount information, and for closing notices where a PSB confirms a notice is closed and further action is not required. Workflows for actuals may be used when there are funds due or a refund due. The actuals workflow does not need to be used if there are no amounts or refund due on a notice. However, if the actuals workflow is used (e.g. amount due) then the abatement workflow may be made available for access. Furthermore, if the actuals workflow is used then users may research, attach documents and create letters to place in the details of the notice and for communicating findings to the client. Furthermore, the research users discover as they receive new information related to the issue may be added into the research notes until completion of the request or until operation of the abatement request workflow. Furthermore, a research workflow may not be made available when the notice is denoted as entered, completed or closed. The present embodiment provides the capability to monitor actions related to notices and determine appropriate actions aiding in the future avoidance of similar notices. Furthermore, as a result of monitoring based on notice types and volumes the system may suggest possible procedural changes for reducing notices. In many practical applications, this capability also provides statistical and analytical information useful for determining and reporting ways for reducing the volume of notices received by PSBs.

The present embodiment provides the capability to generate and view reports of notice related information. In many practical applications, the configuration for displaying reports by users is often more straightforward, intuitive and provides users with information for resolving notice related issues. Reports include, but are not limited to, information relating a synopsis of the intended use for the report and the type of information incorporated in the report. Reports can be executed within several areas of the present embodiment including, but not limited to, client, notice, agency and system GUIs. Report information provided in these areas reduces the time and effort required by users for configuring and executing reports. Sorting and filtering capabilities are provided for the various report types enabling users to generate reports tailored for their particular need or circumstance.

Agency GUIs provide PSBs with information regarding the various agencies. For each agency the GUI may display departments, department addresses, department contacts, PSB required identification information, PSB personal identification numbers, online payment information, website links, and news feeds. The agency notice tracking system allows users to store information needed and required for dealing with each agency. Some agencies provide websites where the PSB can access and retrieve information for their clients. Processing may be provided to allow integration of agency notice tracking system with the agency's websites. Furthermore, the company's identification information and personal identification numbers may be maintained so accessing the agency websites may be automated and accessing the information needed for verification to resolve notices. The news feed is used with respect to agency matters weblog and displays topics and discussions regarding agencies. Furthermore, agency's individual departments are displayed with address and contact information available as needed. The users may put in the addresses they use on each individual agency so when they create a template letters for an agency the system displays the addresses they put on the individual agency. The agency notice tracking system may display approved filing frequencies and deadlines for each department. Furthermore, the agency notice tracking system provides clients of a PSB the capability to file a multiplicity of forms for opening or closing an account. Furthermore, users can select to add new clients for the agency and allow a user to select the client and automatically configure enrolment forms needed for the client with the PSB information listed. The agency notice tracking system may operate to provide backup information and instructions on each agencies procedures. Agency information for a PSB may be stored, organized and provided as a reference for staff members. Furthermore, agency GUIs may display client specific notes related to a given agency. Furthermore, providing agency information via GUIs from centrally organized information reduces the time required for PSBs to research and to correct notices.

The present embodiment provides advanced reporting capability, for example, to sort notices with respect to a particular client so efforts performed by the PSB and information related to the client's notices can be transmitted to the client by, but not limited to, email, letter and facsimile.

The present embodiment's support for system customization provides PSBs the capability to configure their systems as needed. Customized dropdown menu selections can be configured for meeting specific criteria as needed. These customized dropdown menu selections allows the PSB to create their own workflows for custom notice types, cause of notice, corrective action, follow up, and closure reasons.

The present embodiment provides the capability to determine sources of errors and inefficiencies in the notice resolution process and to avoid or ameliorate the causes of errors and inefficiencies in future efforts.

The present embodiment reduces effort and costs by providing the capability to pre-notify agencies when adjustments to client's quarterly or annual returns are to be applied. Pre-notification reduces the amount of notices and communications received by PSBs from the various agencies. Additionally, the present embodiment provides the capability to pre-notify agencies with respect to requests for additional time needed for resolving adjustments to returns. This enables PSBs with the capability to receive prior approval from agencies for additional time before the due date for a notice has been transgressed.

The present embodiment provides, but is not limited to providing, Internet access by PSBs to agencies, thereby enabling the agencies with access to information they require. Internet access provided by the agencies to the agency notice tracking system increases the efficiency and reduces the cost for PSBs in resolving notices. The functions provided by Internet access from PSBs to the agency notice tracking system includes, but is not limited to, secure login, notice research, correspondence with agency and forms retrieval. Furthermore, agency Internet access provided to the agency notice tracking system enables PSBs to communicate, but is not limited to, advanced warnings for adjustments and client changes. Allowing agencies secure Internet access to the present embodiment's information maintained by PSBs provides agencies and PSBs the capability to proactively resolve notices. Proactive resolution of notices reduces costs and increases efficiencies for the notice process.

The present embodiment provides users the capability for improving their functionality through incorporation of updates and enhancements required for future needs. The present embodiment aids PSBs in dealing with agencies and their respective notices. The present embodiment streamlines and automates notice management needs encountered by PSBs increasing their efficiency and accuracy while reducing their costs.

The agency notice tracking system enables users to automate their processes for resolving agency tax notices. This automation enables increases in efficiency and reductions in the amount of time effort required to resolve notices. Furthermore, the increased efficiency derived from the present embodiment reduces the number of notices received from agencies which reduces costs. The automation provided by the present embodiment reduces penalties and interest caused as a result of late payments applied to notices. The present embodiment reduces costs as information related to notices is globally accessible by staff members, clients and agents with appropriate access privileges.

The agency notice tracking system provides the capability to track workloads and place company goals on the number of notices completed and closed per month, quarter and year. Furthermore, the agency notice tracking system provides it users the capability to auto assign notices based off but not limited to; notice type, level, agency, local agency, difficulty level, priority, etc. User can be assigned skill levels and configured to receive notices matching their skill level or lower. Users have the ability to add custom template letters into the system. Fields are accessible on the custom letters letting the clients have full access to customizing the letters to meet their needs. Furthermore, users may be provided the capability to create their own letters and reports at the system level. Furthermore, the agency notice tracking system provides users with the capability to configure alerts based off multiple alert items (e.g. due date, status change, multiple notices, etc.).

The present embodiment may operate to provide a means and method for users to enter notices in bulk. In some cases, a notice may be processed for a multiplicity of clients. Entering notices in bulk may provide a significant reduction in effort, time and cost for processing notices.

The present embodiment may operate to provide a means and method for receipt and processing of notices received via facsimile for a Rapid Notice Entry. Received facsimiles may be converted to Portable Document Format (PDF) and transmitted to a notice entry account for further processing. Furthermore, information included in the received facsimile may be decoded and used for electronic data entry for further processing of the notice.

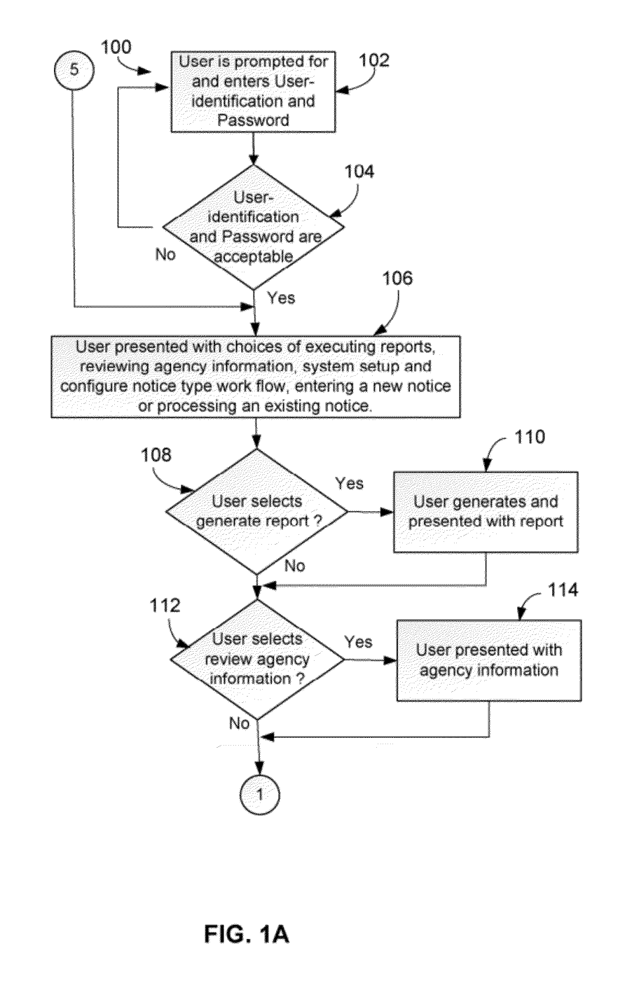

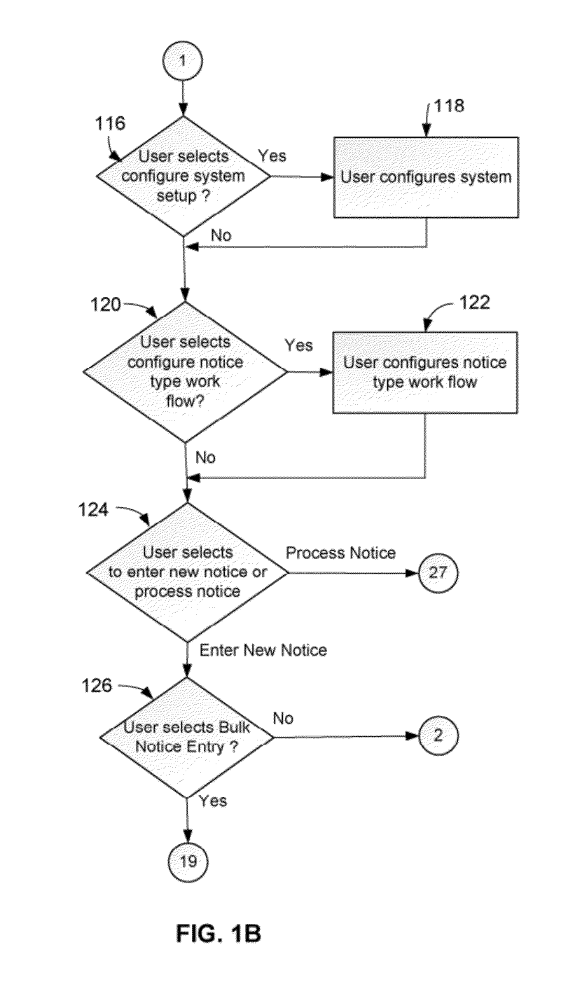

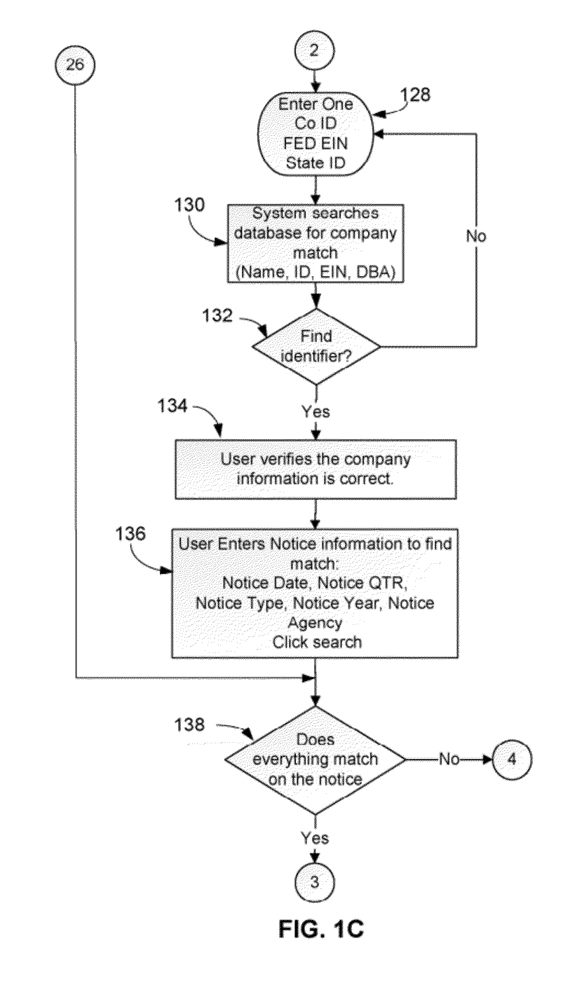

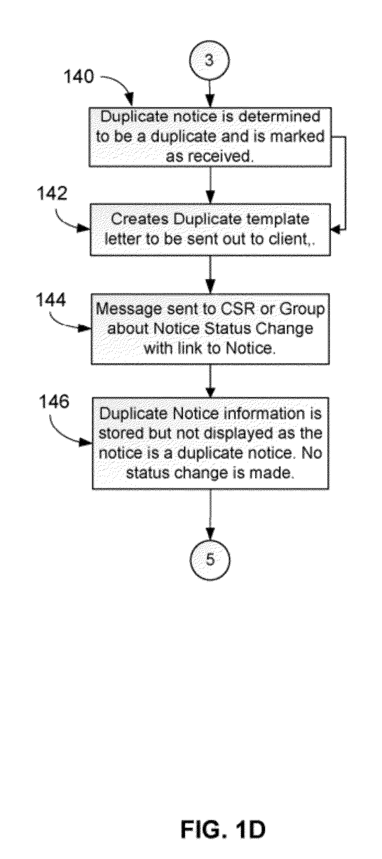

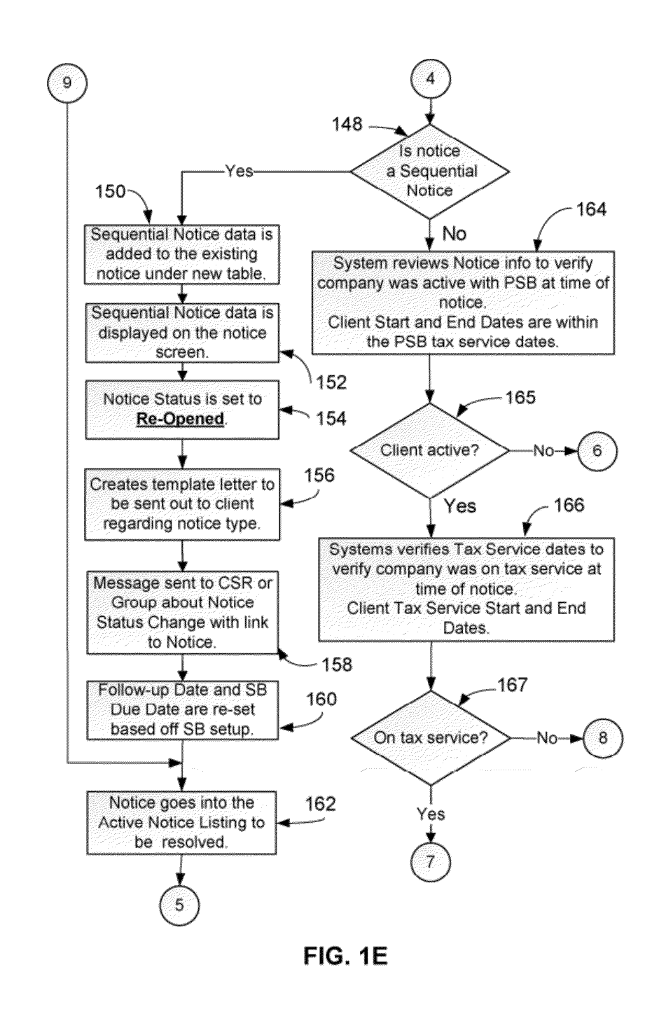

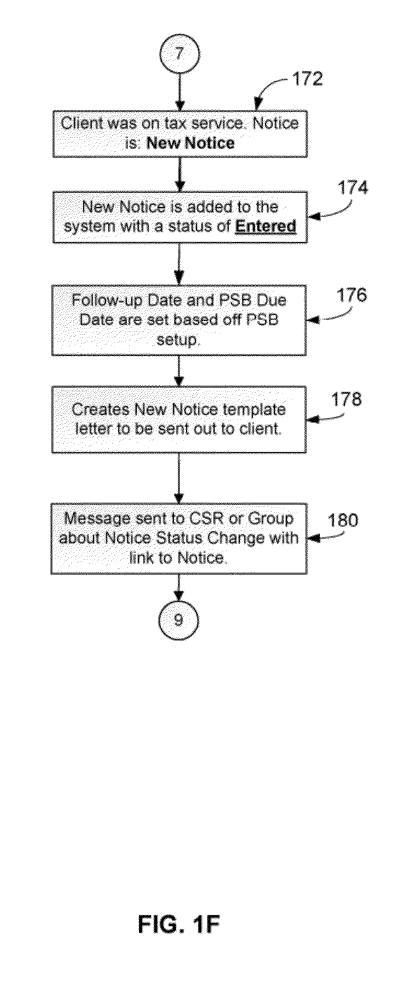

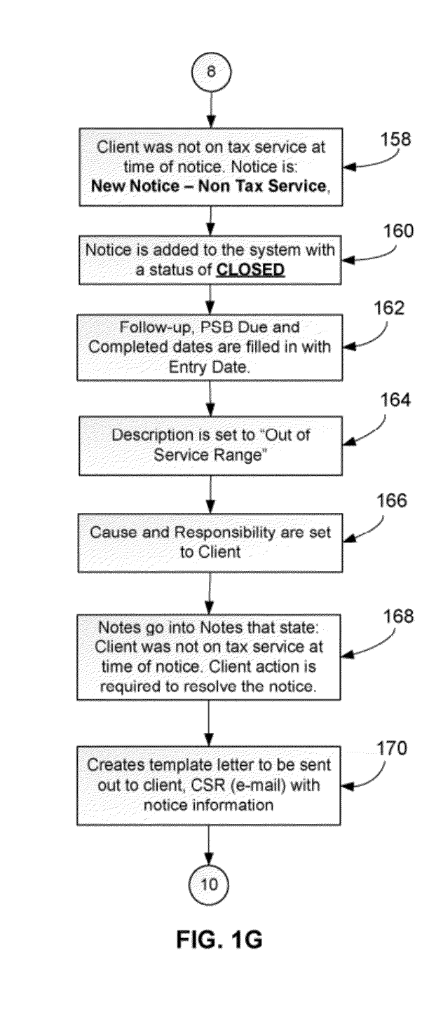

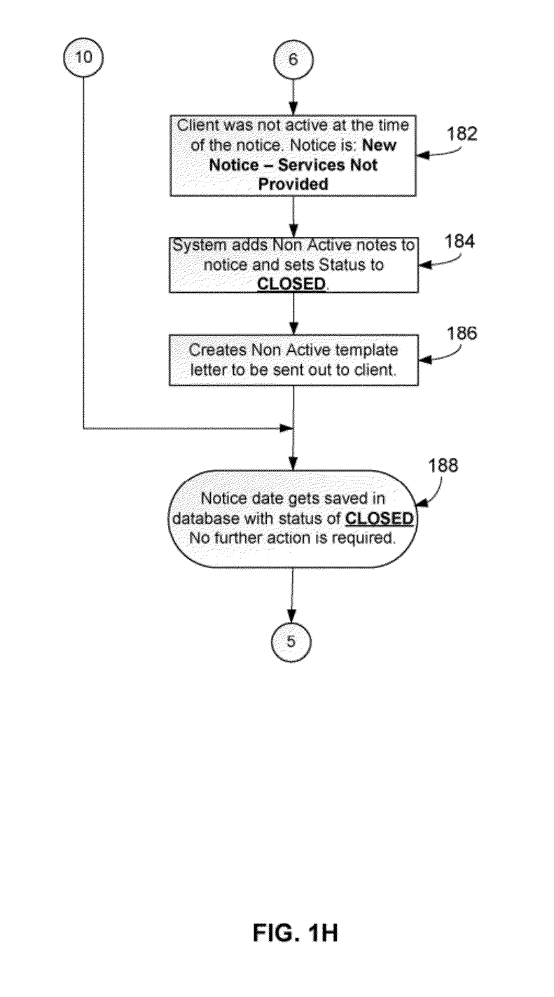

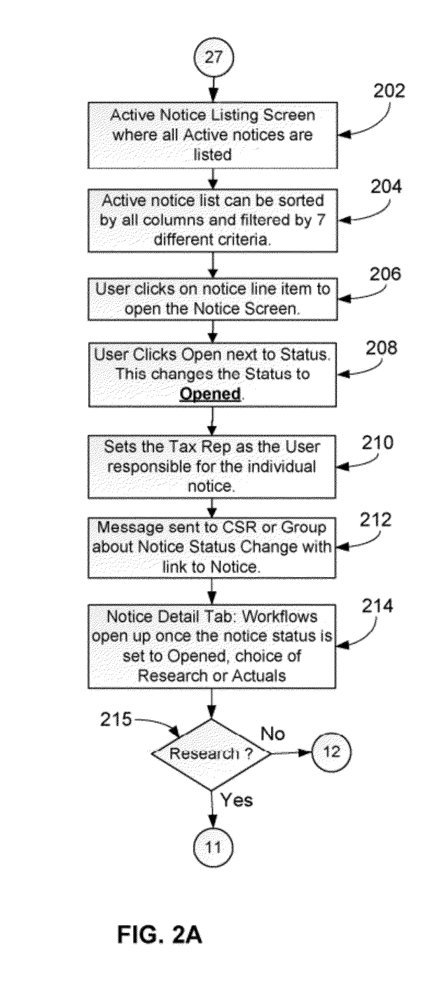

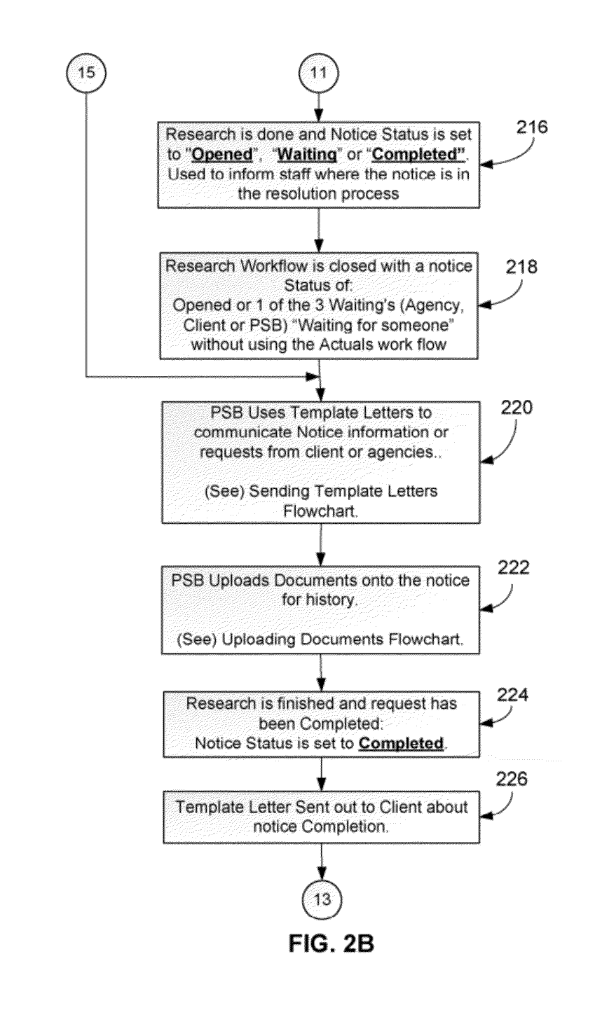

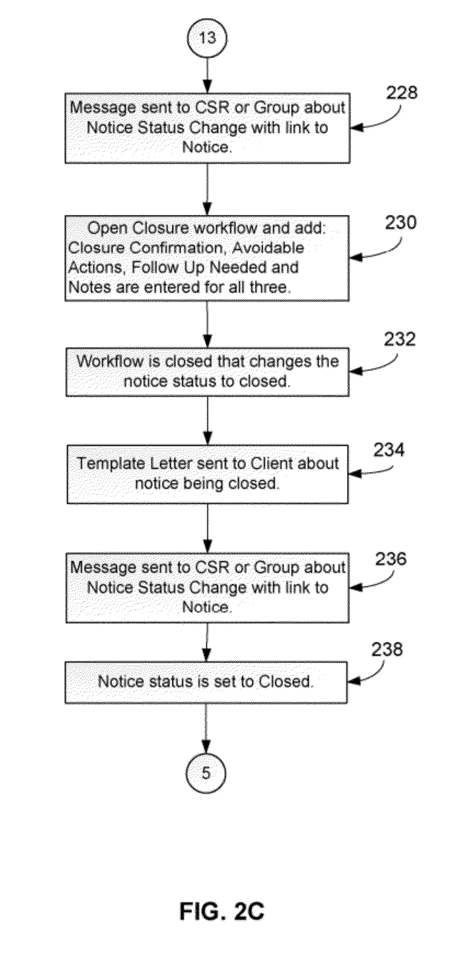

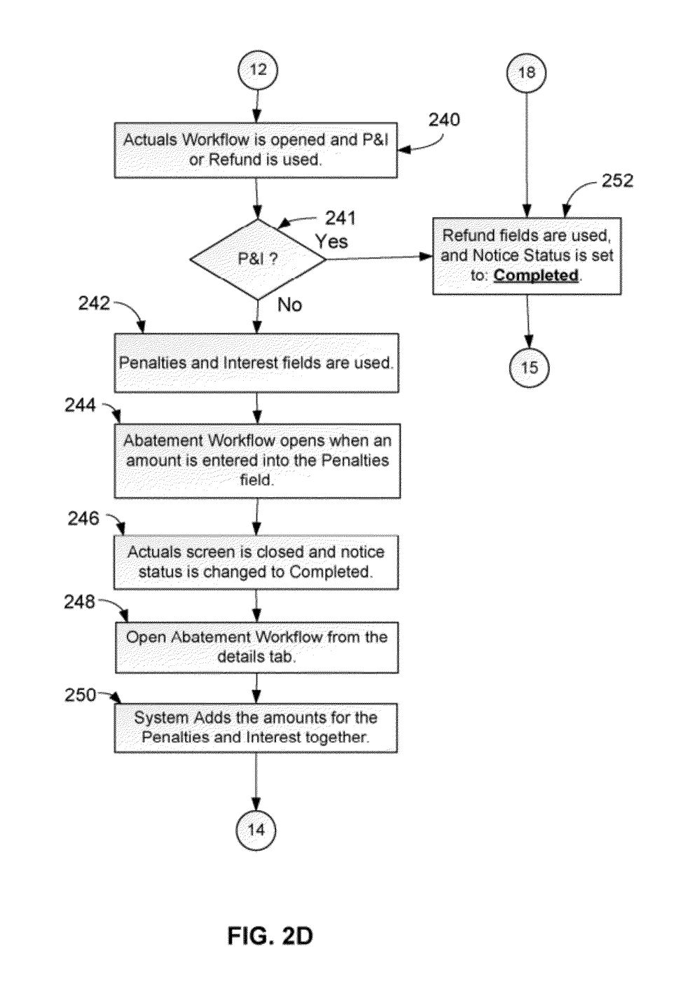

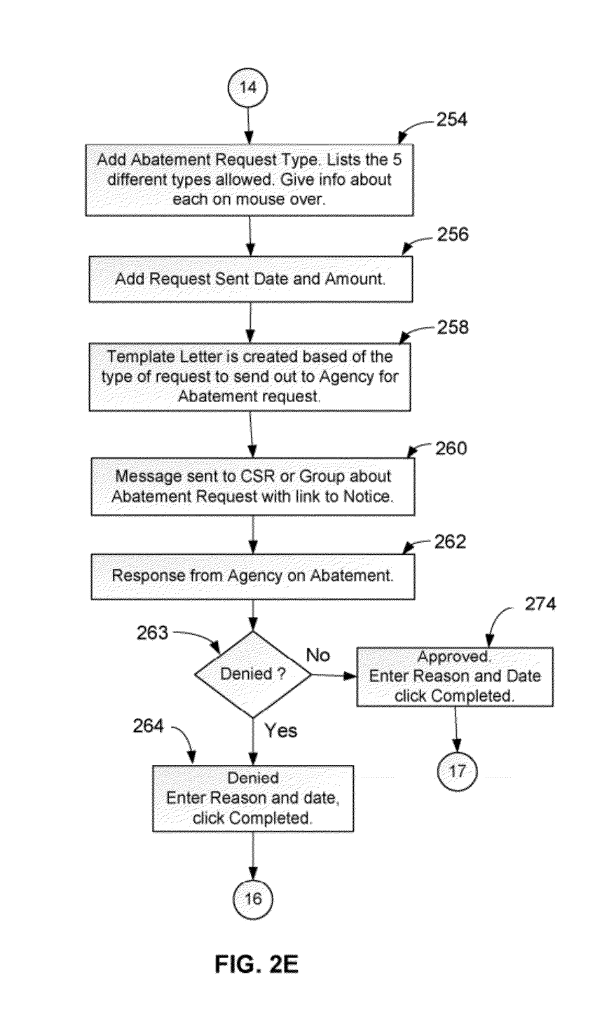

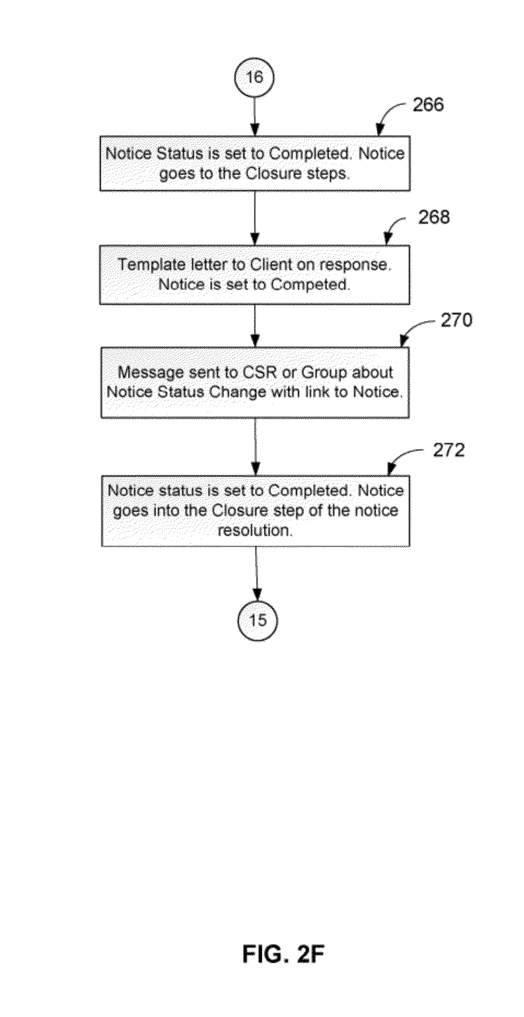

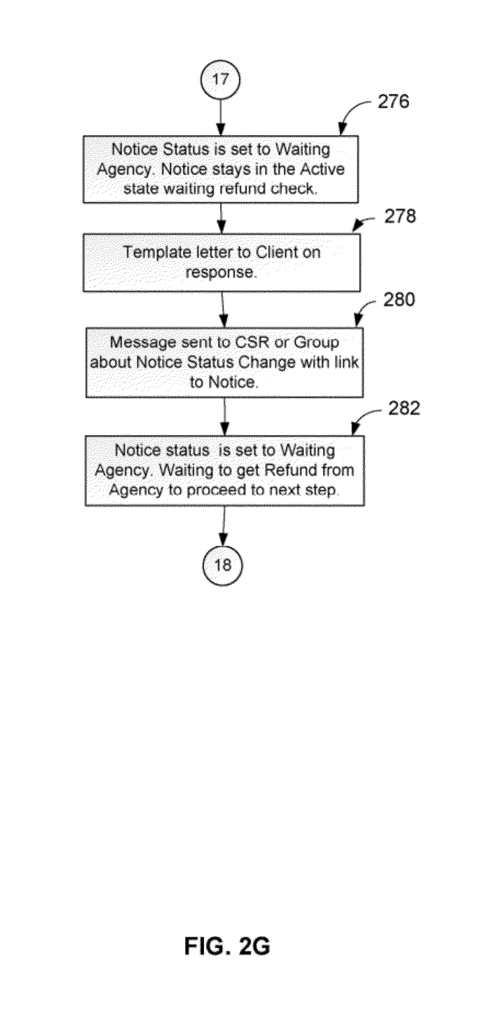

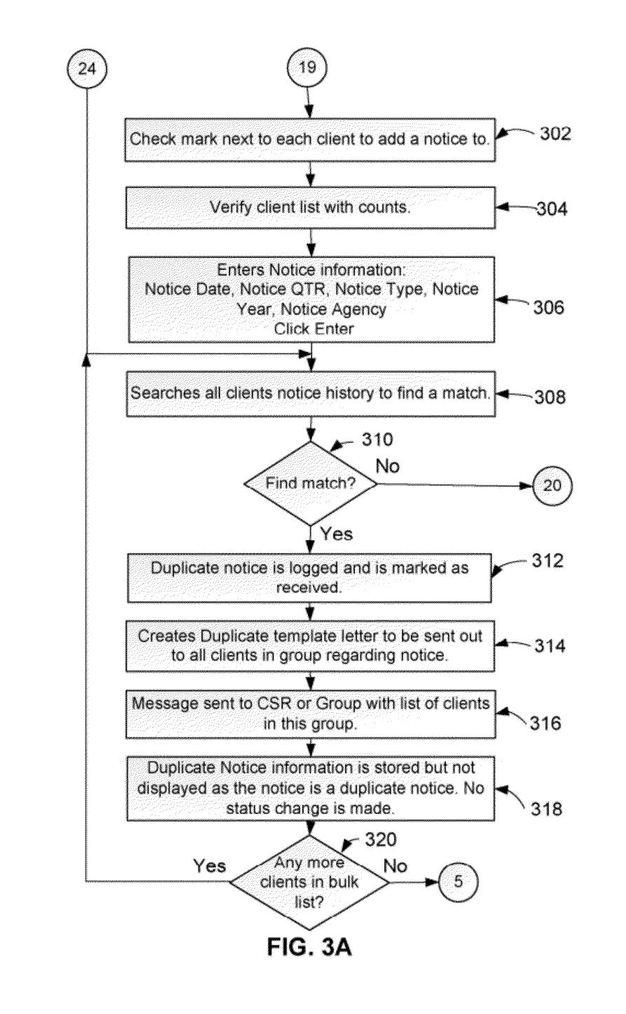

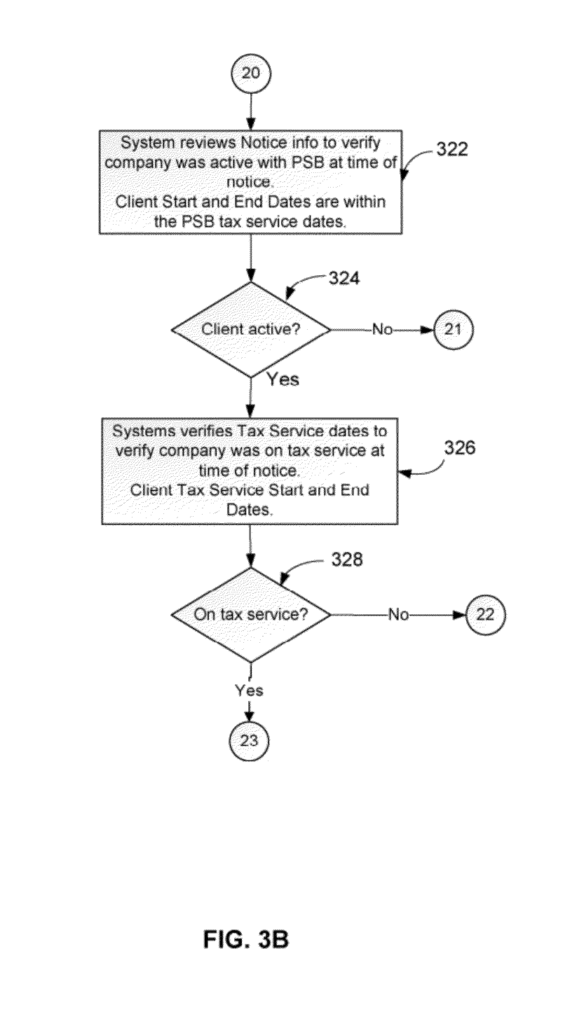

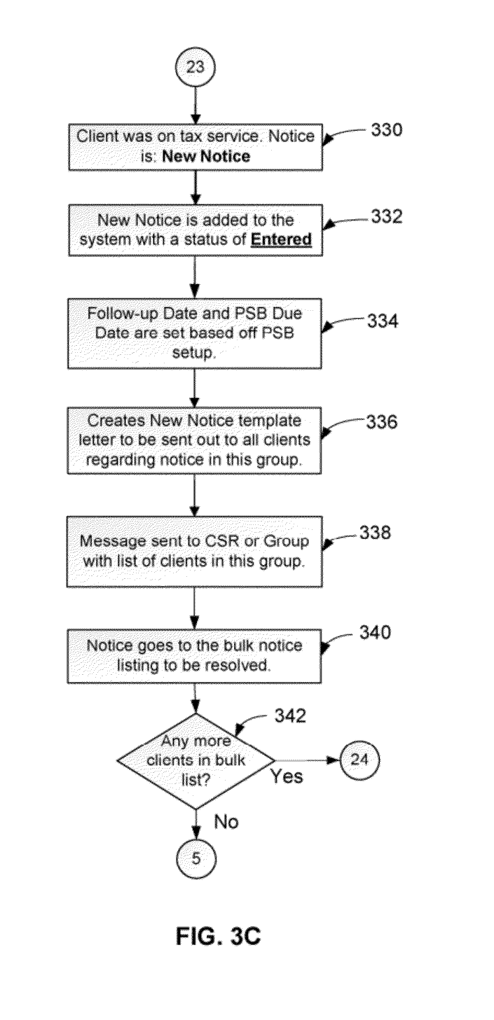

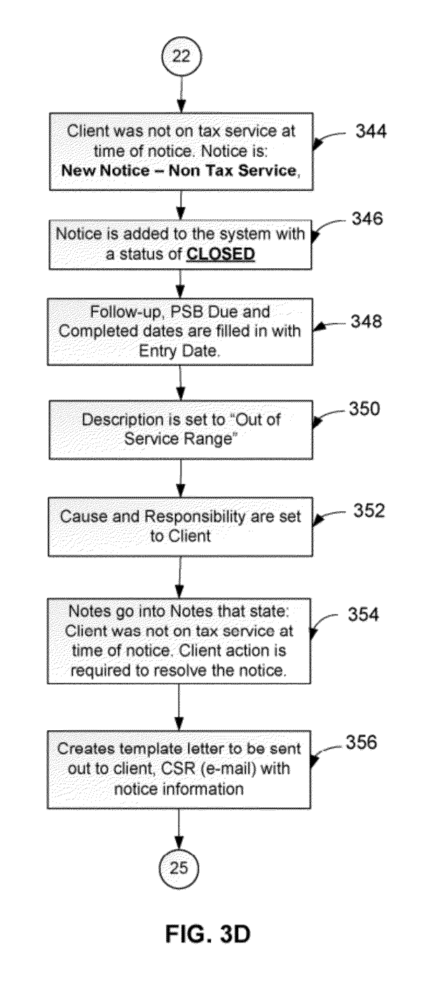

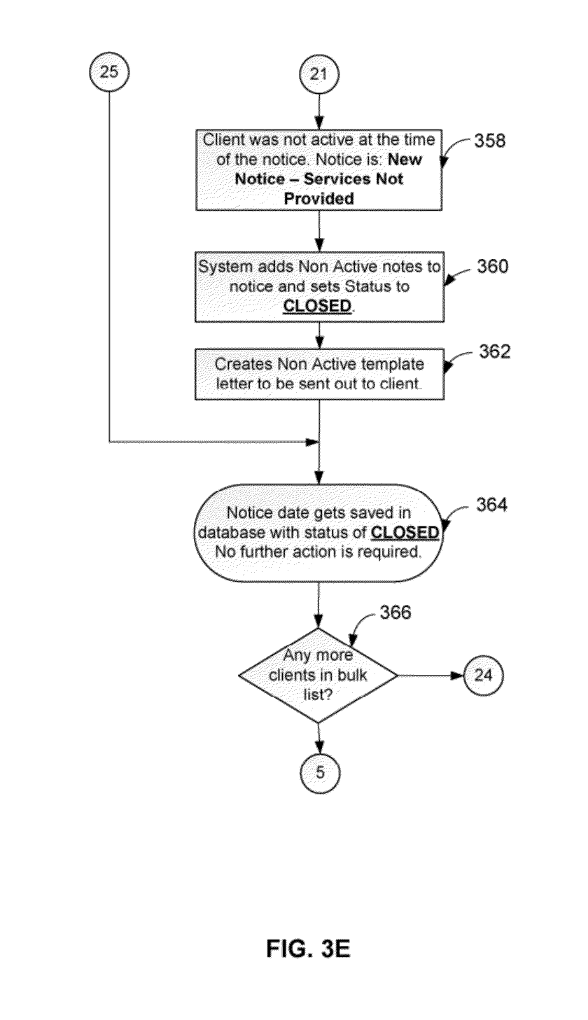

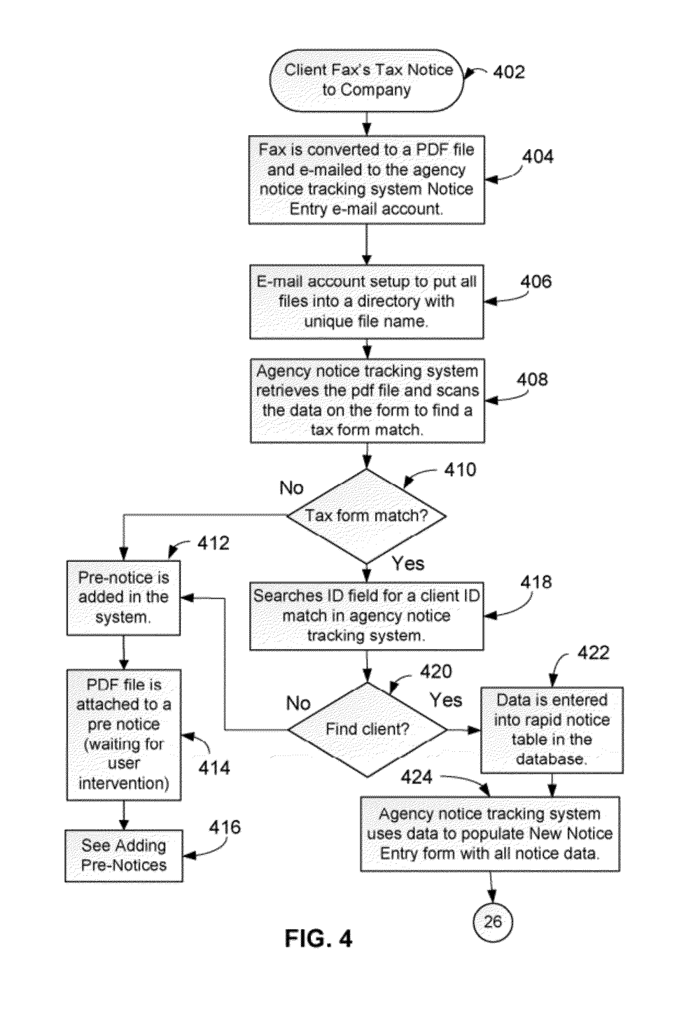

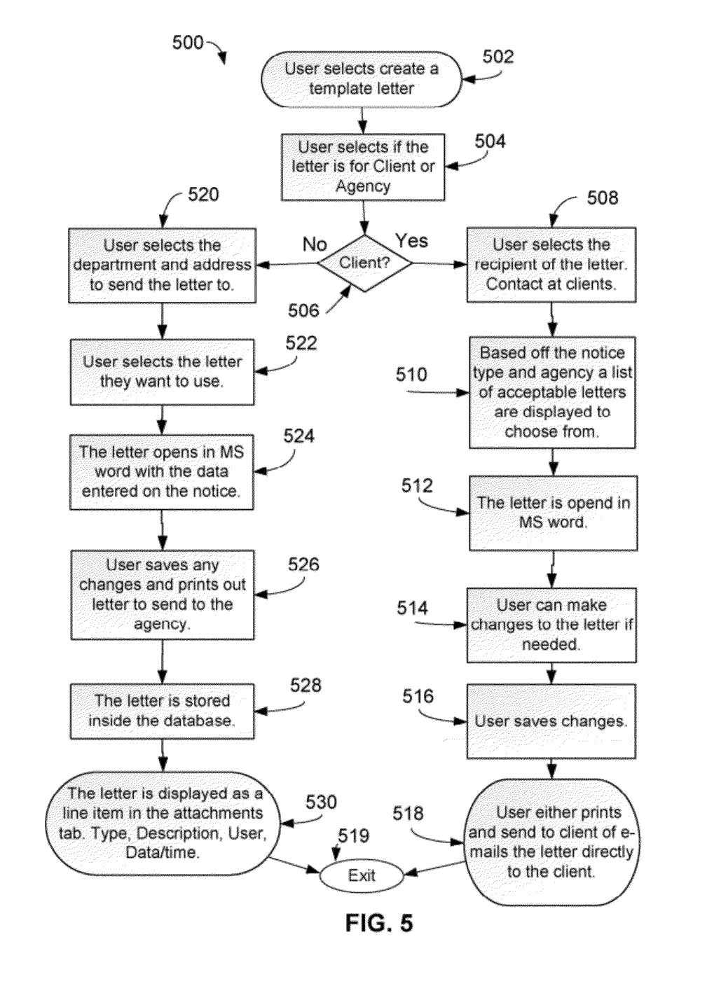

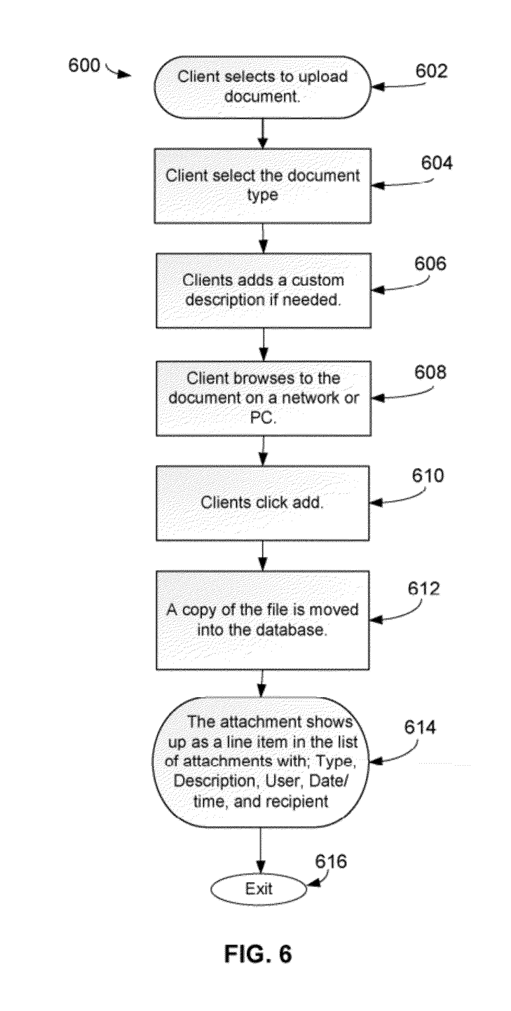

FIGS. 1A-H, FIGS. 2A-G, FIGS. 3A-E, FIG. 4, FIG. 5 and FIG. 6 presents a flow chart illustrating an exemplary method 100 for an agency notice tracking system, in accordance with an embodiment of the present invention.

FIGS. 1A-H presents a flow chart illustrating entry of a new notice for a Quick Tax Notice Entry for an agency notice tracking system, in accordance with an embodiment of the present invention.

In the present embodiment, the method 100 begins in FIG. 1A in a step 102 where a user (not shown) may be prompted to enter a user-identification and password, for example, without limitation, by a display device, smart-phone, or cellular telephone.

In a step 104, it may be determined if user enters a valid user-identification and password.

For a determination of not entering a valid user-identification and password in step 104, user may be informed of an incorrect entry. Furthermore, method 100 may operate to transition to step 102 where user may be prompted to enter a valid user-identification and password.

For a determination of entering a valid user-identification and password in step 104, user may be prompted to select the next course of action in a step 106 with choices including, but not limited to, enter a new notice, process an existing notice, generate reports, review agency information, configure system settings and configure notice type workflows.

In a step 108, it may be determined if user seeks to generate a report.

For a determination of user seeking to generate a report in step 108, user may generate and be presented with report in a step 110.

In a step 112, it may be determined if user seeks to review agency information.

For a determination of user seeking to review agency information in step 112, user may be presented with agency information in a step 114.

In a step 116 (FIG. 1B), it may be determined if user seeks to configure system setup.

For a determination of user seeking to configure system setup in step 116, user may configure system in a step 118.

In a step 120, it may be determined if user selects to configure notice type workflow.

For a determination of user selecting to configure notice type workflow in step 120, user may configure notice type workflow in a step 122.

In a step 124, it may be determined if user seeks to process a notice.

For a determination of user not selecting to process a notice in step 124, it may be determined in a step 126 if user seeks to perform bulk notice entry.

For a determination of user not selecting to perform bulk notice entry in step 126, user may be prompted in a step 128 (FIG. 1C), with choices including, but not limited to, entering a company, federal employer or state identifier. Method 100 may in a step 130 operate to perform a database search for the identifier entered by the user in step 128. In a step 132, a determination for a found identifier may be performed. For a determination of not finding the identifier in step 132, user may be notified of the condition for an unfound identifier with execution of method 100 transitioning to step 128 where user may be prompted to enter a proper identifier.

For a determination of finding the identifier in step 132, the information related to the company matching the identifier may be displayed to the user in a step 134 and user may thereby verify the company information provided on the notice matches the company information found in the database and displayed to the user.

User enters and submits notice information in a step 136 including, but not limited to, issue date, quarter, notice type, year, agency, agency department, amount due, refund amount, local tax jurisdiction, tax notice form, and notice category. In a step 138, method 100 may operate to compare the notice information entered and submitted by the user with information contained in the database. It first verifies that the client was active with the PSB at the time of the notice, if the client is on tax service, or if there are other notices for the same agency and tax period.

For a determination of notice information matching database information in step 138, notice may be denoted as a duplicate notice and in a step 140 (FIG. 1D) the notice may be denoted by the system as having been received.

In a step 142 a duplicate template letter is created and sent out to the client. The duplicate letter may, but not limited to, explain the reasons and times frames for duplicates notices to the clients and lets them know what to expect next.

In a step 144, a notification may be transmitted by, but not limited to, email to the customer service representative or group concerning the duplicate notice. The notification to the CSR or group includes, but is not limited to, information related to the notice and a link to the received Notice.

In a step 146, the received notice information may be stored in the database, but not displayed or denoted as a new notice as the notice may be considered a duplicate. Furthermore, no change in status may be noted by the method 100 related to the received notice, as the notice may be considered a duplicate. When receiving a duplicate notice no status change may be denoted, however, a status change may be denoted when receiving a sequential notice. Following step 146, execution of method 100 may transition to step 106 (FIG. 1A).

For a determination of client, agency or local agency and tax period entered matching a previous notice in step 138 (FIG. 1C), it may be determined in a step 148 (FIG. 1E) if the received notice may be considered a sequential notice.

For a determination of the received notice being considered a sequential notice to a prior received notice in step 148, method 100 may in a step 150 operate to add the newly received sequential notice information to the prior notice into the notice table.

In a step 152, the sequential notice information may be displayed on the notice GUI.

In a step 154, the status of the notice may be denoted as re-opened.

In a step 156, a template letter notification may be transmitted to the customer by, but not limited to, a letter regarding the sequential notification. A notification may be transmitted in a step 158 to the CSR or group related to the notice status change by, but not limited to, email. The transmitted notification includes, but is not limited to, information related to the notice and a link to the notice. Method 100 may determine in a step 160, in accordance with, but not limited by, the system configuration, a revised follow-up date and due date related to the newly received sequential notice information. As a result of the sequential notice information being received, the notice may be submitted in a step 162 to the active notice listing with a status of re-opened and to be resolved.

For a determination of the notice not being a sequential notice in step 148, in a step 164 method 100 may evaluate the notice to verify the status of the company as active. A status may be determined as active or inactive by comparing the start and end dates of the client with the issue date of the notice.

It may be determined in a step 165 whether the status of a client may be considered as active.

For a determination of an active client in step 165, it may be determined in a step 166 whether the PSB may be considered subject to the time period for the notice. For example, a business may have moved to a new payroll provider during the time period for the notice and the PSB may be considered not responsible for resolving the notice.

It may be determined in a step 167 whether a client may be considered as on tax service.

For a determination of the PSB subject to the notice as a result of client being on tax service in step 167, the notice may be denoted as a new notice in a step 172 (FIG. 1F) and in a step 174 the notice may be added to the system with the status of entered.

Dates for future action may be determined in a step 176. Non-limiting examples of future actions which may be determined in step 176 include PSB follow-up date, PSB Completion date, PSB due date and agency due date for the notice. These dates may be stored in the database and determined based upon the configuration of the system and based upon the notice type.

A new notice template may be created in a step 178 for transmission to the client by, but not limited to, a letter and/or e-mail.

A notice message may be transmitted in a step 180 to, but not limited to, the CSR or group concerning the new notice with, but not limited to, basic notice information and a link to the notice.

The notice may then be placed in the active notice listing in step 162 (FIG. 1E) with a status of entered with the notice to be opened, completed and resolved.

For a determination of PSB not subject to the notice in step 167 (FIG. 1E), the notice may be denoted as a new notice—non tax service in step 158 (FIG. 1G).

In step 160 the process may denote the notice as closed and a template letter may be created for transmission to the client informing the client of their responsibility for resolving the notice.

In step 162 the entry date may be attributed to several dates including, but not limited to, PSB follow-up, PSB completion date, and agency due date.

In step 164 the description of the notice may be denoted as out of service range and in step 166 the responsibility for the notice may be attributed to the client.

In a step 168 comments may be added to the notes for the notice denoting the PSB as not subject to the notice for the related time frame and denoting an action by the client may be required in order to resolve the notice.

A template letter related to the notice may be created in a step 170 for transmission to entities of interest including, but not limited to, client and CSR by, but not limited to, letter and email.

In a step 188 (FIG. 1H), the status of the notice may be denoted as closed with the status and date of the notice posted to the database.

For a determination of an inactive client with the PSB at the time of the notice in step 165 (FIG. 1E), the notice may be denoted as new notice—services not provided in a step 182 (FIG. 1H).

In a step 184, the process may add non active notes to the notice and may post the status of the notice to the database as closed.

The process in a step 186 may create a non active template to be transmitted to the client by, but not limited to, a letter.

In step 188, the status of the notice may be denoted as closed and with the status information stored in the database. Furthermore, no further action may be required of the PSB.

FIGS. 2A-G presents a flow chart illustrating processing of a notice for an agency notice tracking system, in accordance with an embodiment of the present invention.

For a determination of a user selecting to process a notice in step 124 (FIG. 1B), the active notice listing of active notices may be displayed to the user in a step 202 (FIG. 2A).

The user may in a step 204 choose to sort the displayed information by column and also by various other criteria including, but not limited to, CSR, tax representative, notice type, agency, local agency, difficulty level, category, past due, priority and status.

The user may select a line item notice of interest in a step 206 in order to open the respective notice for viewing.

The user may select to modify the status of the notice to opened in a step 208.

The user may be denoted as the entity responsible for managing the notice in a step 210 with the notation information stored in the database.

In a step 212 a message may be transmitted to, but not limited by, the CSR or group by, but not limited to, email concerning the status of the notice with, but not limited to, information related to the notice and the representative responsible for resolving the notice with a link to the notice.

Once the user has selected to open a notice, the user may in a step 214 choose several options including, but not limited to, performing research (e.g. searching for details related to reasons for receiving a notice) or actuals (e.g. the actual amounts paid or refunded) workflow. The total amount paid to or refunded by the agency may be referred to as “actuals”.

In a step 215, it may be determined whether user selects to perform research.

For a determination of user selecting to perform research in step 215, user may in a step 216 (FIG. 2B) perform research related to the notice and determine whether the status of the notice should be denoted as opened, waiting or completed thereby informing staff as to the status of the notice.

The user may in a step 218 choose to denote the status of the notice as, but not limited to, leave open, waiting for agency, waiting for client and/or waiting for PSB.

Depending upon the status of the notice in a step 220, the user may select a template to transmit by, but not limited to, letter, letters or email to the appropriate entity or entities including, but not limited to, agencies or client. More detailed information related to template letters and template letter creation will be discussed with reference to FIG. 5.

In a step 222, user may upload notice related information discovered during workflow research to the database. More detailed information related to uploading notice related information will be discussed with reference to FIG. 6.

After the user has completed research and uploaded the related information and completed the request of the notice, the status of the notice may be denoted as completed in a step 224.

A template letter may be created in a step 226 for transmission to the client by, but not limited to, letter regarding the completion of the effort related to the notice. Transmitted letters may inform the client of efforts performed and may also inform the client of future events.

A message may be transmitted in a step 228 (FIG. 2C) by, but not limited to, email to the CSR or group related to the status of the notice with a link to the notice.

After completing the research workflow, the user may be prompted to perform closure workflow in a step 230 by adding the following information including, but not limited to, closure confirmation type, closure notes, avoidable actions, avoidable action notes, follow-up information, follow-up notes, and billing information.

In a step 232, the closure workflow may be denoted and submitted as closed to the database.

In a step 234, a template letter may be created and transmitted to the client by, but not limited to, a letter informing the client of a closed notice, efforts performed and reason for transmission of notice.

A message may be created and transmitted in a step 236 to, but not limited to, the CSR or group with information related to the notice status change with a link to the notice.

The notice status may be denoted as closed and submitted to database in a step 238.

Following step 238, execution of method 100 may transition to step 106 (FIG. 1A).

For a determination of user selecting actuals workflow in step 215 (FIG. 2A), user may be prompted in a step 240 (FIG. 2D) to select an actuals workflow including, but not limited to, penalties and interest or refund.

In a step 241, it may be determined whether user selects an actuals workflow of penalties and interest or refund.

For a determination of user selecting penalties and interest in step 241, user may be displayed a penalties and interest GUI in a step 242 and may be prompted to enter a penalty amount after which an abatement workflow may be entered in a step 244.

In a step 246, the actuals GUI may be closed and the status of the notice may be denoted as completed.

The user may then open an abatement workflow in a step 248 from the notice details tab after which the sum of the penalties and interest may be calculated in a step 250.

The user may then prompted in a step 254 (FIG. 2E) to select an abatement request type from a list including, but not limited to, administrative waiver, correction of service error, good compliance records, reasonable cause, and statutory exception and the user may be able to view information related to the abatement request type by, but not limited to, placing a pointing device over the abatement request type. The information displayed may provide users examples of possible reasons for abatements with the ability to select a template letter best meeting their needs. An amount for abatement and the date for its transmission to the Agency may be determined in a step 256.

Template letters may be created in a step 258 based upon the type of abatement selected to be transmitted to, but not limited by, the client, the agency by, but not limited to, a letter, e-mail, or electronic form. One letter may be transmitted to the client explaining the abatement process and timeframe and a second letter may be transmitted to the Agency requesting the abatement. A message related to the abatement request may be transmitted to the CSR or group in a step 260 by, but not limited to, email with a link to the notice. A response may be received from the agency related to the abatement in a step 262.

In a step 263, a determination may be performed related to the acceptance or denial of an abatement request.

For a determination of a denied abatement request in step 263, the user may submit the reason for denial and the respective date to the database in a step 264.

In a step 266 (FIG. 2F), status of notice may be denoted as completed and steps for closure may be initiated. In a step 268 a template letter or other type of notice mechanism may be generated related to the abatement request response and transmitted to the client. A message relating to the change in the notice status may be transmitted in a step 270 to the CSR or group by, but not limited to, email with a link to the notice information. In a step 272 the notice may be transferred to the closure step for completion of the close notice workflow.

Depending upon the status of the notice in step 220 (FIG. 2B), user may select a template to transmit by, but limited to, letter, letters or email to the appropriate entity or entities including, but not limited to, agencies or client. These letters may be pre-formatted such that users may select the correct template letter and needed data may be incorporated in the letters automatically. These letters have been designed by Agency Matters (AM) and field tested to ensure the agency or clients understand their responsibilities, roles, timeframes, deadlines and contain required information for the agencies to correctly post data from notice entry to notice resolution including closure processes. In step 222, the user may upload information discovered during workflow research related to the notice to the database. This information may be pre-defined research items that may be stored relative to the individual notice such as but not limited to payroll reports, quarterly and annual returns, client e-mails, agency notices, agency facsimiles, voice conversations, etc. After the user has completed research and uploaded the notice related information, the status of the notice may be denoted as completed in step 224. A template letter may be created in step 226 for transmission to the client by, but not limited to, letter regarding the completion of the effort related to the notice. A message may be transmitted in step 228 (FIG. 2C) by, but not limited to, email to the CSR or group related to the status of the notice with a link to the notice.

After completing the research workflow, the user may be prompted to perform closure workflow in step 230, by adding the following information including, but not limited to, closure confirmation type, closure notes, avoidable actions, avoidable actions notes, follow-up information, follow-up notes and billing information. There may be individual notes for avoidable actions and the follow-up actions to aid with isolating the action notes. In step 232, the closure workflow may be denoted and submitted as closed to the database. In step 234, a template letter may be created and transmitted to the client by, but not limited to, a letter informing the client of a closed notice, efforts performed and reason for transmission of notice. A message may be created and transmitted in step 236 to the CSR or group with information related to the notice status change with a link to the notice. The notice status may be denoted as closed and submitted to database in step 238.

Following step 238, execution of method 100 may transition to step 106 (FIG. 1A).

For a determination of an approved abatement in step 263 (FIG. 2E), the user may enter the reason and date and denote the notice as completed in a step 274. Furthermore, a template letter may be created for updating the client regarding the response. Furthermore, for an approved abatement, the agency notice tracking system may operate to prepare for and denote a forthcoming refund notice from the agency.

The status of the notice may be denoted as waiting refund in a step 276 (FIG. 2G), and the notice may remain in the active state while waiting for the refund check from the agency. A template letter or other notice mechanism may be created related to the approval of the abatement in a step 278 and transmitted to the client. A message related to the status of the notice may be created in a step 280 and transmitted to the CSR or group by, but not limited to, email with a link to the notice. The notice status may be denoted as waiting to get refund from agency in a step 282. Furthermore, following receipt of the refund, method 100 may continue to the next step.

After receipt of the refund from the agency, the status of the notice may be denoted as completed in a step 252 (FIG. 2D). Following step 252 execution of method 100 may transition to the closure workflow in step 220 (FIG. 2B) to close out the notice and notify parties of the resolution.

Depending upon the status of the notice in step 220, user may select a template to transmit by, but limited to, letter, letters or email to the appropriate entity or entities including, but not limited to, agencies or client. In step 222, the user may upload information found during workflow research related to the notice to the database. After the user has completed research and uploaded the notice related information, the status of the notice may be denoted as completed in step 224. A template letter may be created in step 226 for transmission to the client by, but not limited to, letter regarding the completion of the effort related to the notice. A message may be transmitted in step 228 (FIG. 2C) by, but not limited to, email to the CSR or group related to the status of the notice with a link to the notice.

After completing the research workflow, the user may be prompted to perform closure workflow in step 230, by adding the following information including, but not limited to, closure confirmation type, avoidable actions, avoidable actions notes, follow-up information, follow-up notes and billing information. In step 232, the closure workflow may be denoted and submitted as closed to the database. In step 234, a template letter may be created and transmitted to the client by, but not limited to, a letter informing the client of a closed notice and the related details regarding the resolution. A message may be created and transmitted in step 236 to the CSR or group with information related to the change in notice status with a link to the notice. The notice status may be denoted as closed and submitted to database in step 238.

For a determination of selecting a refund in step 241 (FIG. 2D), the status of the notice may be denoted as completed in step 252 after receiving a refund from the agency.

Depending upon the status of the notice in step 220 (FIG. 2B), user may select a template to transmit by, but limited to, letter, letters or email to the appropriate entity or entities including, but not limited to, agencies or client. In step 222, the user may upload information found during workflow research related to the notice to the database. After the user has completed research and uploaded the notice related information, the status of the notice may be denoted as completed in step 224. A template letter may be created in step 226 for transmission to the client by, but not limited to, letter regarding the completion of the effort related to the notice. A message may be transmitted in step 228 (FIG. 2C) by, but not limited to, email to the CSR or group related to the status of the notice with a link to the notice.

After completing the research workflow, the user may be prompted to perform closure workflow in step 230, by adding the following information including, but not limited to, closure confirmation type, closure notes, avoidable actions, avoidable action notes, follow-up information, follow-up notes. In step 232, the closure workflow may be denoted and submitted as closed to the database. In step 234, a template letter may be created and transmitted to the client by, but not limited to, a letter informing the client of the closed notice and the related details. A message may be created and transmitted in step 236 to the CSR or group with information related to the change in notice status of closed with a link to the notice. The notice status may be denoted as closed and submitted to database in step 238.

FIGS. 3A-E presents a flow chart illustrating entry of a bulk tax notice entry for an agency notice tracking system, in accordance with an embodiment of the present invention.

Bulk tax notice entry may be used to enter the same notice type from the same agency and agency department for the same time period for multiple clients in a single transaction.

For a determination of selection a bulk tax notice entry in step 126 (FIG. 1B), user may select clients, for example, but not limited to, with a digital check off sheet GUI, for addition of a notice in a step 302 (FIG. 3A).

In a step 304, client list may be verified via client counts in order to ensure accounting for every client.

In a step 306, information may be entered regarding the notice. Non-limiting information which may be entered includes notice date, notice quarter, notice agency, agency department, notice type, notice year and received date.

In a step 308, a search for a match related to client notice history may be performed.

In a step 310, a determination for a match discovered in step 308 may be performed.

For a determination of a match in step 310, a duplicate notice may be denoted in a step 312 as received and stored in the database.

In a step 314, a duplicate template letter may be created and transmitted to every client in the group regarding the notice.

In a step 316, a message may be sent to CSR or group with a list of clients included in the group.

In a step 318, duplicate information may be stored in the database. Furthermore, the duplicate notice information may not be displayed as the notice may be considered a duplicate notice. Furthermore, no change in status may be denoted.

In a step 320, it may be determined if any more clients included in bulk list remain to be searched.

For a determination of clients remaining in bulk list to be searched, execution of method 100 may transition to step 308.

For a determination of no clients remaining in bulk list to be searched, execution of method 100 may transition to step 106 (FIG. 1A).

For a determination of not finding a match in step 310 (FIG. 3A), in a step 322 (FIG. 3B) method 100 may evaluate the notice to verify the status of the company as active. A status may be determined as active or inactive by comparing the start and end dates of the client with the issue date of the notice.

It may be determined in a step 324 whether the status of a client may be considered as active.

For a determination of an active client in step 324, it may be determined in a step 326 whether the PSB may be considered subject to the time period for the notice. For example, a business may have moved to a new payroll provider during the time period for the notice and the PSB may be considered not responsible for resolving the notice.

It may be determined in a step 328 whether a client may be considered as on tax service.

For a determination of the PSB subject to the notice as a result of client being on tax service in step 328, the notice may be denoted as a new notice in a step 330 (FIG. 3C) and in a step 332 the notice may be added to the system with the status of entered.

Dates for future action may be determined in a step 334. Non-limiting examples of future actions which may be determined in step 334 include PSB follow-up date, PSB Completion date, PSB due date and agency due date for the notice. These dates may be stored in the database and determined based upon the configuration of the system and based off the notice type.

A new notice template may be created in a step 336 for transmission to the client by, but not limited to, a letter and/or e-mail.

A notice message may be transmitted in a step 338 to, but not limited to, the CSR or group concerning the new notice with, but not limited to, basic notice information and a link to the notice.

The notice may then be placed in the active notice listing screen with an action type of bulk notice in a step 340 with a status of entered with the notice to be opened, completed and resolved.

In a step 342, it may be determined if more clients remain in bulk list to be processed.

For a determination of no remaining clients in bulk list to be processed in step 342, execution of method 100 may transition to step 106 (FIG. 1A).

For a determination of clients remaining in bulk list to be processed in step 342, execution of method 100 may transition to step 308 (FIG. 3A).

For a determination of PSB not subject to the notice in step 328 (FIG. 3B), the notice may be denoted as a new notice—non tax service in a step 344 (FIG. 3D).

In a step 346 the process may denote the notice as closed and a template letter may be created and transmitted to the client informing the client of their responsibility for resolving the notice.

In a step 348 the entry date may be attributed to several dates including, but not limited to, PSB follow-up, PSB completion date, and agency due date.

In a step 350 the description of the notice may be denoted as out of service range and in a step 352 the responsibility for the notice may be attributed to the client.

In a step 354 comments may be added to the notes for the notice denoting the PSB as not subject to the notice for the related time frame and denoting an action by the client may be required in order to resolve the notice.

A template letter related to the notice may be created in a step 356 for transmission to entities of interest including, but not limited to, client and CSR by, but not limited to, letter and email.

In a step 364 (FIG. 3E), the status of the notice may be denoted as closed with the status and date of the notice posted to the database.

In a step 366, it may be determined if any clients remain in bulk list for processing.

For a determination of no remaining clients in bulk list to process in step 366, execution of method 100 may transition to step 106 (FIG. 1A).

For a determination of remaining clients in bulk list to process in step 366, execution of method 100 may transition to step 308 (FIG. 3A).

For a determination of an inactive client with the PSB at the time of the notice in step 324 (FIG. 3B), the notice may be denoted as new notice—services not provided in a step 358 (FIG. 3E).

In a step 360, the process may add non active notes to the notice and may post the status of the notice to the database as closed.

The process in a step 362 may create a non active template to be transmitted to the client by, but not limited to, a letter.

In step 364, the status of the notice may be denoted as closed and with the status information stored in the database. Furthermore, no further action may be required of the PSB.

In step 366, it may be determined if any clients remain in bulk list for processing.

For a determination of no remaining clients in bulk list to process in step 366, execution of method 100 may transition to step 106 (FIG. 1A).

For a determination of remaining clients in bulk list to process in step 366, execution of method 100 may transition to step 308 (FIG. 3A).

FIG. 4 presents a flow chart illustrating Rapid Tax Notice Entry for an agency notice tracking system, in accordance with an embodiment of the present invention.

For rapid tax notice entry, PSB clients may transmit a notice to the PSB via facsimile and the agency notice tracking system scans and enters the notice electronically. In a non-limiting example, a fax cover page has the client code on it. If no cover page exits or the system cannot find a match on the client and/or the tax form then system attaches a pdf file of the facsimile to a pre-notice screen to have someone verify it and add it manually into system through the Quick Tax Notice Entry workflow. If it's a bogus fax then the user can delete the pre-notice entry from the system.

In a step 402, clients may transmit a notice to the PSB via facsimile with predefined client and optional agency identifiers that the client will denote.

In a step 404, the received facsimile may be converted to PDF format and e-mailed to an account configured for receiving notices via facsimile.

In a step 406, the PDF file may be stored in a network directory accessible by the agency notice tracking system.

In a step 408, the agency notice tracking system may retrieve the PDF file stored in the network directory and verify the client ID and Agency on the first page and it will compare the PDF file to the agency notice tracking system notice library in order to find a form matching the notice.

In a step 410, a determination for finding a matching form may be performed.

For a determination of no match found in step 410, the notice may be transferred into the pre-notice listing in a step 412. Quick Notice Entry will be updated in the next 100 days to allow all none identifiable faxes to be submitted into a Pre-Notice screen. This part of the Rapid notice entry will use these features and list all notices or “faxes” on a list as Pre-Notice's. When they open the pre-notice the PDF will be displayed on screen with the notice entry options as they are now in step 136. The users can enter the notice manually from the data displayed on the notice entry screen from the PDF file. If it is a bogus fax they can delete the Pre-notice from the system.

In a step 414, the PDF notice file may be attached to the pre-notice.

In a step 416, user may enter the pre-notice screen and manually add the notice into the agency notice tracking system.

For a determination of the agency notice tacking system finding a matching form for the notice in step 410, the agency notice tracking system may scan the notice in a step 418 to retrieve information from the PDF file. The information retrieved from the notice includes but not limited to client code, client EIN or state identification, client name, notice type, tax period, amount due, refund due, notice form number and due date. The agency and client retrieved information may be transferred to a temporary table in the database.

In a step 420, the agency notice tracking system may operate to search the client table for a client match.

For a determination of not finding a matching client in step 420, execution of method 100 may transition to step 412.

For a determination of finding a matching client in step 420 the notice and client information may be transferred to the rapid notice table in a step 422.

In a step 424, the agency notice tracking system may utilize the information retrieved from the notice to populate the quick notice entry form for entry of the notice. (see Step 218 Quick Tax Notice Entry).

Following step 424, execution of method 100 may transition to step 138 (FIG. 1C).

FIG. 5 presents a flow chart illustrating creation of a template letter for an agency notice tracking system, in accordance with an embodiment of the present invention.

In the present embodiment, a method 500 begins in a step 502 where user may select to create a template letter.

In a step 504, a user may opt to select to create a template letter for a client or an agency.

In a step 506, it may be determined whether user selects to create a template letter for a client or an agency.

For a determination of selecting a client in step 506, user may select the recipient of the letter from the clients contact list with titles in a step 508.

In a step 510, a list of acceptable letters, as determined by the notice type and agency, may be displayed for user to select from.

In a step 512, the selected template letter may be accessed by user via a word processing application and has preformatted client and agency and PSB information in it linked back to the database.

In a step 514, user may modify template letter as needed.

In a step 516, user may save modified letter is saved onto the individual notice in the database.

In a step 518, user may transmit the letter to the client. Non-limiting examples of methods for transmission of letter include mail and email.

For a determination of user selecting an agency in step 506, user may in step 520 select agency related information for transmission of the letter. Non-limiting examples of agency related information includes department, address, and/or contact related information.

In a step 522, user may select a template letter for modification.

In a step 524, user may access template letter via a word processing application. Template letter may be populated with related information for agency.

In a step 526, user may save modified template letter and send the letter to the agency. Non-limiting examples of methods for transmission of letter include mail and email.

In a step 528, the letter may be stored in the database.

In a step 530, the letter may be denoted as a line item in the attachments tab with related associated information. Non-limiting examples of related associated information includes type, description, user, recipient, and date/time.

Following step 518 or step 530, method 500 may terminate operation in a step 519.

FIG. 6 presents a flow chart illustrating uploading a document for an agency notice tracking system, in accordance with an embodiment of the present invention.

In the present embodiment, a method 600 begins in a step 602 where a client may select to upload a document to the agency notice tracking system.

In a step 604, client may select the type of document for uploading.

In a step 606, client may add a custom description related to the uploaded document.

In a step 608, client may search or browse for the document on a network or a local computing device.

In a step 610, client may select to add the document to the agency notice tracking system.

In a step 612, a copy of the selected file may be transferred to the agency notice tracking system.

In a step 614, client may verify the upload of the document in addition to other related information. Non-limiting examples of other related information includes type, description, user, date/time, from and recipient.

Method 600 may terminate execution in a step 616.

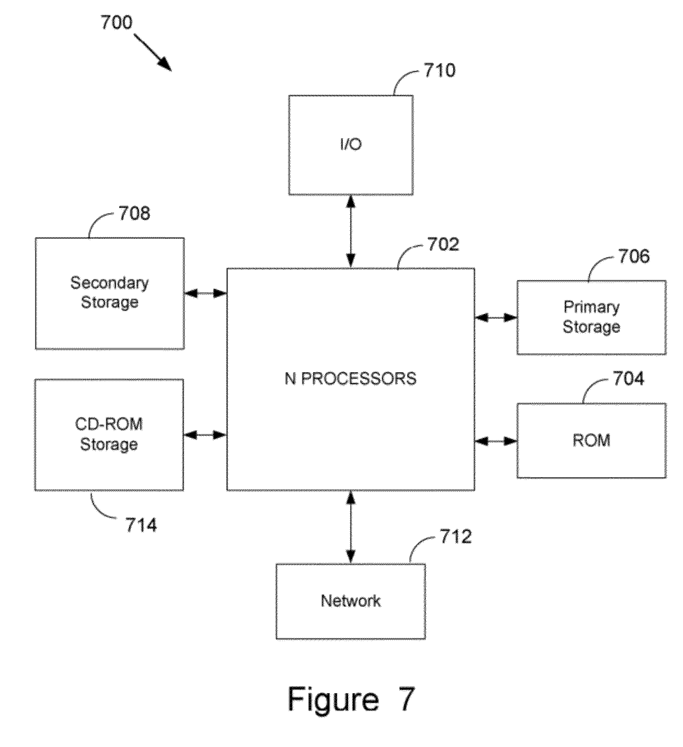

FIG. 7 illustrates a typical computer system that, when appropriately configured or designed, can serve as a computer system 700 in which the present invention may be embodied.

Computer system 700 includes a quantity of processors 702 (also referred to as central processing units, or CPUs) that are coupled to storage devices including a primary storage 706 (typically a random access memory, or RAM), a primary storage 704 (typically a read only memory, or ROM). CPU 702 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 704 acts to transfer data and instructions uni-directionally to the CPU and primary storage 706 is used typically to transfer data and instructions in a bi-directional manner. The primary storage devices discussed previously may include any suitable non-transitory computer-readable media such as those described above. A mass storage device 708 may also be coupled bi-directionally to CPU 702 and provides additional data storage capacity and may include any of the non-transitory computer-readable media described above. Mass storage device 708 may be used to store programs, data and the like and is typically a secondary storage medium such as a hard disk. It will be appreciated that the information retained within the mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 may also be coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications or internet network using an external connection shown generally as a network 712, which may be implemented as a hardwired or wireless communications link using suitable conventional technologies. With such a connection, the CPU might receive information from the network, or might output information to the network in the course of performing the method steps described in the teachings of the present invention.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

In alternate embodiments of the present invention the only aspects from the above embodiments that are implemented are the steps of entering, opening, researching, adding notice data, communicating it to clients and Agencies, completing the notice, closing the notice, and communicating results, whereby all other features and/or steps are optional.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, the notice data storing, tracking, analyzing, managing, sharing, resolving, reporting and/or communicating may be performed and/or located on a server outside of the jurisdiction of the USA while the remaining method steps and/or system components of the forgoing embodiments are typically required to be located/performed in the US for practical considerations.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

Having fully described at least one embodiment of the present invention, other equivalent or alternative methods of handling accounting notices according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method comprising:
steps for entering information from at least one agency tax notification into a system using a workflow presented by the system where said system is operable to search a database, to determine a status of said at least one agency tax notification, to generate a template letter, and to place said at least one agency tax notification on an active notice listing dependent upon said determined status;
steps for selecting an active notification from said active notice listing to process using a workflow and retrieved information presented by said system;
steps for selecting a research workflow and entering results of said research into said system where said system is operable to store said research results in said database, to determine a change in status, and to generate a template letter; and
steps for selecting an actuals workflow for payment of penalties and interest or receipt of refund where said system is operable for presenting an abatement workflow when penalties and interest are due, generates template letters and presents a closure workflow when said processing is complete.

2. The method as recited in claim 1, further comprising steps for configuring a workflow for a type of an agency tax notification.

3. The method as recited in claim 1, further comprising steps for creating a template letter.

4. A method comprising the steps of:
entering information from at least one agency tax notification into a system using a workflow presented by the system where said system is operable to search a database for a company matching an identifier from said entered information and to present results from said search for verification, said system further operable to determine a status of said at least one agency tax notification, to generate a template letter regarding said at least one agency tax notification and said determined status to be communicated to the company, and to place said at least one agency tax notification on an active notice listing dependent upon said determined status;
selecting an active notification from said active notice listing to process using a workflow presented by said system where said system is operable to retrieve information associated with said selected active notification;
selecting a research workflow if research of said selected active notification is required to resolve said selected active notification and entering results of said research into said system where said system is operable to store said research results in said database, to determine a change in status of said selected active notification dependent upon said research results, and to generate a template letter regarding said selected active notification and said determined status to be communicated to the company of said selected active notification; and
selecting an actuals workflow if payment of penalties and interest or receipt of refund is required to complete said processing of said selected active notification where said system is operable to present an abatement workflow when penalties and interest are due and to generate template letters to be communicated to the company of said selected active notification and an agency responsible for said selected active notification, said system being further operable for presenting a closure workflow when said processing is complete.

5. The method as recited in claim 4, in which said at least one agency tax notification is received via a transmission from the company for automated entry into said system.

6. The method as recited in claim 4, in which said at least one agency tax notification is associated with a plurality of companies and said system generates a multiple company notice and generates a template letter for each company.

7. The method as recited in claim 4, in which said system is further operable for determining if said at least one agency tax notification is a duplicate of a previously entered agency tax notification.

8. The method as recited in claim 4, in which said system is further operable for determining if said at least one agency tax notification is a sequential notice of a previously entered agency tax notification and for adding said sequential notice to said previously entered agency tax notification.

9. The method as recited in claim 4, in which said system is further operable for identifying a type of said at least one agency tax notification to enable said system to present workflows associated with said type.

10. The method as recited in claim 9, further comprising the step of configuring a workflow for said type.

11. The method as recited in claim 4, further comprising the step of creating a template letter.

12. The method as recited in claim 4, in which said system is further operable to save in said database a document supplied by the company.

13. The method as recited in claim 4, in which said retrieved information associated with said selected active notification comprises agency contact information and identification required to represent the company of said selected active notification.

14. A system comprising:
means for storing company and agency information;
means for non-transitorily storing a plurality of instructions;
means for executing said instructions; and
means for entering information from at least one agency tax notification into said storing means where execution of said instructions cause said executing means to: search said storing means for a company matching an identifier from said entered information; present results from said search for verification; determine a status of said at least one agency tax notification; generate a template letter regarding said at least one agency tax notification and said determined status to be communicated to the company; and place said at least one agency tax notification on an active notice listing dependent upon said determined status, said entering means being further operable for selecting an active notification from said active notice listing to process using a workflow where execution of said instructions cause said executing means to retrieve information associated with said selected active notification, said entering means being further operable for selecting a research workflow if research of said selected active notification is required to resolve said selected active notification and for entering results of said research where execution of said instructions cause said executing means to: store said research results in said storing means; determine a change in status of said selected active notification dependent upon said research results; and generate a template letter regarding said selected active notification and said determined status to be communicated to the company of said selected active notification, and said interface being further operable for selecting an actuals workflow if payment of penalties and interest or receipt of refund is required to complete said processing of said selected active notification where execution of said instructions cause said executing means to: present an abatement workflow when penalties and interest are due; generate template letters to be communicated to the company of said selected active notification and an agency responsible for said selected active notification; and present a closure workflow when said processing is complete.

15. The system as recited in claim 14, further comprising means for said at least one agency tax notification to be received via a transmission from the company for automated entry into said system.

16. A system comprising:
a database for storing company and agency information;
a storage means for non-transitorily storing a plurality of instructions;
one or more processors operable for executing said instructions; and
an interface, under control of said one or more processors executing said instructions, operable for entering information from at least one agency tax notification into said database using a workflow presented by said interface where execution of said instructions cause said one or more processors to: search said database for a company matching an identifier from said entered information; present results from said search for verification; determine a status of said at least one agency tax notification; generate a template letter regarding said at least one agency tax notification and said determined status to be communicated to the company; and place said at least one agency tax notification on an active notice listing dependent upon said determined status, said interface being further operable for selecting an active notification from said active notice listing to process using a workflow where execution of said instructions cause said one or more processors to retrieve information associated with said selected active notification, said interface being further operable for selecting a research workflow if research of said selected active notification is required to resolve said selected active notification and for entering results of said research where execution of said instructions cause said one or more processors to: store said research results in said database; determine a change in status of said selected active notification dependent upon said research results; and generate a template letter regarding said selected active notification and said determined status to be communicated to the company of said selected active notification, and said interface being further operable for selecting an actuals workflow if payment of penalties and interest or receipt of refund is required to complete said processing of said selected active notification where execution of said instructions cause said one or more processors to: present an abatement workflow when penalties and interest are due; generate template letters to be communicated to the company of said selected active notification and an agency responsible for said selected active notification; and present a closure workflow when said processing is complete.

17. The system as recited in claim 16, further comprising a network by which said at least one agency tax notification is received via a transmission from the company for automated entry into said system.

18. The system as recited in claim 16, in which said at least one agency tax notification is associated with a plurality of companies and execution of said instructions cause said one or more processors to generate a multiple company notice and generate a template letter for each company.

19. The system as recited in claim 16, in which execution of said instructions cause said one or more processors to determine if said at least one agency tax notification is a duplicate of a previously entered agency tax notification.

20. The system as recited in claim 16, in which execution of said instructions cause said one or more processors to determine if said at least one agency tax notification is a sequential notice of a previously entered agency tax notification and to add said sequential notice to said previously entered agency tax notification.

21. The system as recited in claim 16, in which execution of said instructions cause said one or more processors to identify a type of said at least one agency tax notification to enable presentation of workflows associated with said type.

22. The system as recited in claim 21, in which said interface being further operable for configuring a workflow for said type.

23. The system as recited in claim 16, in which said interface being further operable for creating a template letter.

24. The system as recited in claim 16, in which execution of said instructions cause said one or more processors to save in said database a document supplied by the company.

25. The system as recited in claim 16, in which said retrieved information associated with said selected active notification comprises agency contact information and identification required to represent the company of said selected active notification.

26. A computer program product residing on or being distributed across one or more non-transitory computer readable mediums having a plurality of instructions stored thereon which, when executed by one or more associated processors, cause the one or more processors to:
enter information from at least one agency tax notification into a system using a workflow presented by the system where said system is operable to search a database for a company matching an identifier from said entered information and to present results from said search for verification, said system further operable to determine a status of said at least one agency tax notification, to generate a template letter regarding said at least one agency tax notification and said determined status to be communicated to the company, and to place said at least one agency tax notification on an active notice listing dependent upon said determined status;
select an active notification from said active notice listing to process using a workflow presented by said system where said system is operable to retrieve information associated with said selected active notification;
select a research workflow if research of said selected active notification is required to resolve said selected active notification and entering results of said research into said system where said system is operable to store said research results in said database, to determine a change in status of said selected active notification dependent upon said research results, and to generate a template letter regarding said selected active notification and said determined status to be communicated to the company of said selected active notification; and
select an actuals workflow if payment of penalties and interest or receipt of refund is required to complete said processing of said selected active notification where said system is operable to present an abatement workflow when penalties and interest are due and to generate template letters to be communicated to the company of said selected active notification and an agency responsible for said selected active notification, said system being further operable for presenting a closure workflow when said processing is complete.

27. The computer program product as recited in claim 26, in which said at least one agency tax notification is received via a transmission from the company for automated entry into said system.

28. The computer program product as recited in claim 26, in which said at least one agency tax notification is associated with a plurality of companies and said system generates a multiple company notice and generates a template letter for each company.

29. The computer program product as recited in claim 26, in which said system is further operable for determining if said at least one agency tax notification is a duplicate of a previously entered agency tax notification.

30. The computer program product as recited in claim 26, in which said system is further operable for determining if said at least one agency tax notification is a sequential notice of a previously entered agency tax notification and for adding said sequential notice to said previously entered agency tax notification.

31. The computer program product computer program product as recited in claim 26, in which said system is further operable for identifying a type of said at least one agency tax notification to enable said system to present workflows associated with said type.

32. The computer program product as recited in claim 31, further comprising instructions when executed by one or more associated processors cause the one or more processors to configuring a workflow for said type.

33. The computer program product as recited in claim 26, further comprising instructions when executed by one or more associated processors cause the one or more processors to creating a template letter.

34. The computer program product as recited in claim 26, in which said system is further operable to save in said database a document supplied by the company.

35. The computer program product as recited in claim 26, in which said retrieved information associated with said selected active notification comprises agency contact information and identification required to represent the company of said selected active notification.
